(19) United States
(12) Patent Application Publication
(10) Pub. No.: US 2016/0154777 A1
(43) Pub. Date: Jun. 2, 2016

(54) DEVICE AND METHOD FOR OUTPUTTING RESPONSE

(71) Applicant: SAMSUNG ELECTRONICS CO., LTD., Suwon-si (KR)

(72) Inventors: Hyun-jae SHIN, Seoul (KR); Ji-hoon PARK, Suwon-si (KR)

(21) Appl. No.: 14/955,740

(22) Filed: Dec. 1, 2015

(30) Foreign Application Priority Data
Dec. 1, 2014 (KR) 10-2014-0169969

(51) Int. Cl. G06F 17/24

(52) U.S. Cl. CPC G06F 17/24

(57) ABSTRACT

Provided are a device and a method for outputting a response to an inquiry. The method includes receiving an input from one or more users; obtaining an inquiry indicated by the input; determining a response level corresponding to a user level of a user from among one or more pre-set response levels; and outputting a response to the inquiry based on the determined response level.

### CROSS-REFERENCE TO RELATED APPLICATION

This application is based on and claims priority under 35 U.S.C. §119 to Korean Patent Application No. 10-2014-0169969, filed on Dec. 1, 2014, in the Korean Intellectual Property Office, the disclosure of which is incorporated by reference herein in its entirety.

### BACKGROUND

1. Field

The disclosure relates to a device and method for outputting a response, and for example, to a device and a method for outputting a response corresponding to an inquiry.

2. Description of Related Art

Based on developments in multimedia technology and data processing technology, devices have become capable of processing various information. In particular, a device for receiving a request and outputting a response corresponding to the received request has come into widespread use. However, a same response is determined for a same request.

Therefore, a method of outputting a user-adaptive response by using information regarding a user who is to receive the response is demanded.

### SUMMARY

Provided are a device and a method for outputting a user-adaptive response.

Additional aspects will be set forth in part in the description which follows and, in part, will be apparent from the description.

According to an aspect of an example embodiment, a method of providing a response to an inquiry includes receiving an input; obtaining an inquiry indicated by the input; determining a response level corresponding to a user level of a user from among one or more pre-set response levels; and outputting a response to the inquiry based on the determined response level.

The obtaining of the inquiry may include determining an input method for the input; and receiving the input based on the determined input method.

The input method may include at least one selected from touch input method, keyboard input method, sound input method, gesture input method, and image input method.

The outputting of the response may include obtaining information regarding the user; determining one or more response corresponding to the inquiry; and outputting one response of the one or more responses based on at least one of the determined response level and the information regarding the user.

The information regarding the user may include at least one of information regarding location of the user, current time information, information regarding a history of responses to the user, information regarding age of the user, and information regarding knowledge level of the user.

The obtaining of the inquiry may include obtaining a keyword using the input; and obtaining an inquiry indicated by the input using the keyword.

The obtaining of the inquiry may further include obtaining an inquiry indicated by the input using at least one of information regarding location of the user, current time information, information regarding a history of responses to the user, information regarding age of the user, and information regarding knowledge level of the user.

The obtaining of the inquiry may further include, if the inquiry corresponding to the input is not obtained, receiving an additional input from the user; and obtaining the inquiry using the additional input.

The determining of the response level may include determining the response level using at least one of information regarding age of the user and information regarding knowledge level of the user.

The outputting of the response may include outputting the response as at least one of a text, a voice, and an image.

According to an aspect of another example embodiment, a device includes an input including input circuitry configured to receive an input and to obtain an inquiry indicated by the input; a controller configured to determine a response level corresponding to a user level of a user from among one or more pre-set response levels; and an output comprising output circuitry configured to output a response to the inquiry based on the determined response level.

The input circuitry may be configured to determine an input method for the input and to receive the input based on the determined input method.

The input method may include at least one of a touch input method, keyboard input method, sound input method, gesture input method, and image input method.

The controller may be configured to obtain information regarding the user, to determine one or more response corresponding to the inquiry, and to output one response of the one or more responses based on at least one of the determined response level and the information regarding the user.

The information regarding the user may include at least one of information regarding location of the user, current time information, information regarding a history of responses to the user, information regarding age of the user, and information regarding knowledge level of the user.

The controller may be configured to obtain a keyword using the input and to obtain an inquiry indicated by the input by using the keyword.

The controller may be configured to obtain an inquiry indicated by the input using at least one of information regarding location of the user, current time information, information regarding a history of responses to the user, information regarding age of the user, and information regarding knowledge level of the user.

If the inquiry corresponding to the input is not obtained, the input circuitry is configured to receive an additional input, and the controller is configured to obtain the inquiry by using the additional input.

The controller may be configured to determine the response level using at least one of information regarding age of the user and information regarding knowledge level of the user.

The controller may be configured to output the response as at least one of a text, a voice, and an image.

According to an aspect of another example embodiment, there is provided a non-transitory computer readable recording medium having recorded thereon a computer program for implementing the above-stated method.

According to an aspect of another example embodiment, there is provided a computer program stored in a non-transitory computer readable recording medium for implementing the above-stated method.

### BRIEF DESCRIPTION OF THE DRAWINGS

These and/or other aspects will become apparent and more readily appreciated from the following detailed description, taken in conjunction with the accompanying drawings, in which like reference numerals refer to like elements, and wherein:

FIG. 1 is a diagram illustrating an example, in which a device receives an input and outputs a response;

FIG. 2 is a flowchart illustrating an example method in which a device outputs a response regarding an inquiry;

FIG. 3 is a diagram illustrating an example, in which a device outputs one from among a plurality of responses to an inquiry;

FIG. 4A is a diagram illustrating an example in which a device determines response levels regarding a plurality of users, respectively;

FIG. 4B is a diagram illustrating an example in which a device determines a response level for a user group;

FIG. 5A is a diagram illustrating an example in which a device provides a response corresponding to an input received from any one user from among a plurality of users to the plurality of users in consideration of a user level of the any one user;

FIG. 5B is a diagram illustrating an example in which a device provides a response corresponding to inputs received from a plurality of users based on user levels of the plurality of users;

FIG. 5C is a diagram illustrating an example in which a device provides a response corresponding to an input received from any one user from among a plurality of users based on a user level of the any one user;

FIG. 5D is a diagram illustrating an example in which a device provides a response corresponding to inputs received from a plurality of users to a particular user based on user levels of the plurality of users;

FIG. 6 is a diagram illustrating an example in which a device receives a text input;

FIG. 7 is a diagram illustrating an example in which a device receives a voice input;

FIG. 8 is a diagram illustrating an example in which a device receives a gesture input;

FIG. 9 is a diagram illustrating an example in which a device includes a wearable device;

FIG. 10 is a diagram illustrating an example in which a device receives an image input;

FIG. 11 is a diagram illustrating an example in which a device receives a sketch input or a touch input;

FIG. 12 is a flowchart illustrating an example method whereby a device outputs a response based on whether a received input is a language input;

FIG. 13 is a diagram illustrating an example in which a device models a user;

FIG. 14 is a diagram illustrating an example in which a device models a user group including a plurality of users;

FIG. 15 is a diagram illustrating an example in which a device displays an input and an output in a split screen image;

FIG. 16 is a diagram illustrating an example in which a device displays an input and an output by switching screen images;

FIG. 17 is a diagram illustrating an example in which a device displays an input and an output by using speech balloons;

FIG. 18 is a diagram illustrating an example in which a device displays an input and an output by using an avatar;

FIG. 19 is a diagram illustrating an example in which a device operates in conjunction with a server or another device;

FIG. 20 is a block diagram illustrating an example configuration of a device; and

FIG. 21 is a block diagram illustrating an example configuration of a device.

### DETAILED DESCRIPTION

Reference will now be made in greater detail to example embodiments, examples of which are illustrated in the accompanying drawings, wherein like reference numerals refer to like elements throughout. The example embodiments may have different forms and should not be construed as being limited to the descriptions set forth herein. The example embodiments are merely described below, by referring to the figures, to explain aspects. As used herein, the term “and/or” includes any and all combinations of one or more of the associated listed items. Expressions such as “at least one selected from,” when preceding a list of elements, modify the entire list of elements and do not modify the individual elements of the list.

Terminologies used in the disclosure will be briefly described, and then the disclosure will be described in greater detail.

Although the terms used in the disclosure are selected from generally known and used terms, some of the terms mentioned in the disclosure have been selected by the applicant at his or her discretion, the detailed meanings of which are described in relevant parts of the description herein.

In addition, unless explicitly described to the contrary, the word “comprise” and variations such as “comprises” or “comprising” will be understood to imply the inclusion of stated elements but not the exclusion of any other elements. In addition, the term “units” described in the specification mean units for processing at least one function and operation and can be implemented by software components or hardware components (e.g., circuitry, including configurable circuitry), such as FPGA or ASIC. However, the “units” are not limited to software components or hardware components. The “units” may be embodied on a recording medium and may be configured to operate one or more processors. Therefore, for example, the “units” may include components, such as software components, object-oriented software components, class components, and task components, processes, functions, properties, procedures, subroutines, program code segments, drivers, firmware, micro codes, circuits, data, databases, data structures, tables, arrays, and variables. Components and functions provided in the “units” may be combined to smaller numbers of components and “units” or may be further divided into larger numbers of components and “units.”

Furthermore, in the disclosure, a “user input” may include at least one selected from a touch input, a keyboard input, a voice input, a sound input, a button input, a gesture input, and a multimodal input. However, the disclosure is not limited thereto.

Furthermore, in the disclosure, a “touch input” may refer to a touch gesture performed by a user to a touch screen and a cover for controlling the device 100. For example, touch inputs stated in the disclosure may include tap, touch & hold, double tap, panning, flicking, and drag-and-drop. However, the disclosure is not limited thereto.

Furthermore, in the disclosure, a “button input” may refer to an input applied by a user via a physical button attached to the device 100 to control the device 100.

Furthermore, in the disclosure, a “gesture input” may refer to a motion applied by a user to the device 100 to apply an input to the device 100. For example, a user may apply a gesture input by rotating the device 100, tilting the device 100, or moving the device 100 upward, downward, leftward, or rightward. The device 100 may, for example, detect a gesture input pre-set by a user by using an acceleration sensor, a tilt sensor, a gyro sensor, a 3-axis magnetic sensor, etc.

Furthermore, in the disclosure, a “gesture input” may refer to an input with respect to a motion of a user for applying an input to a device. A gesture input may, for example, include information regarding a motion that the device 100 obtained from outside of the device 100. For example, a gesture input may include an input based on a motion of a user for pointing out a particular object or an input based on a particular motion of a user. The device 100 may, for example, detect a motion of a user using a camera or an infrared ray sensor and receive a gesture input.

Furthermore, in the disclosure, a “multimodal input” may refer to a combination of at least two input methods. For example, the device 100 may receive a touch input and a motion input from a user or receive a touch input and a voice input from a user. Furthermore, the device 100 may, for example, receive a touch input and an eye input. An eye input may, for example, refer to an input applied by a user by controlling blinking of an eye, a location gazed by an eye, and a speed of moving an eye, to control the device 100.

Furthermore, in the disclosure, an “application” may refer to a set of a series of computer programs devised to perform a particular task. The disclosure may include various applications. For example, applications may include a game application, a movie player application, a map application, a memo application, a calendar application, a phone book application, a broadcasting application, a fitness aid application, a payment application, and a picture folder application, but is not limited thereto.

The disclosure will now be described more fully with reference to the accompanying drawings, in which example embodiments are illustrated. In the disclosure, if it is determined that a detailed description of commonly-used technologies or structures related to the disclosure may unnecessarily obscure the subject matter of the disclosure, the detailed description may be omitted.

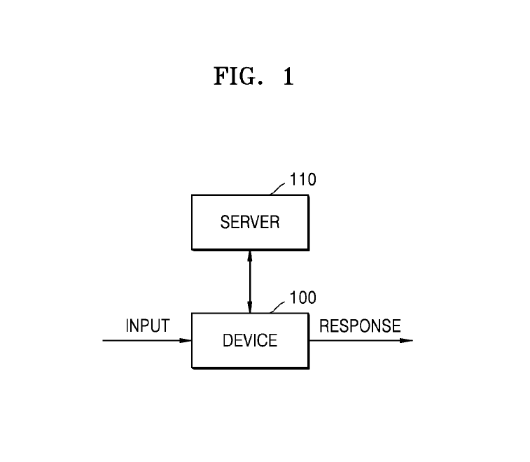

FIG. 1 is a diagram illustrating an example of a device 100.

The device 100 may be configured to receive inputs from outside of the device 100. Inputs received by the device 100 may include user inputs. User inputs may, for example, include at least one selected from a touch input, a keyboard input, a voice input, a sound input, a button input, a gesture input, and a multimodal input.

The device 100 may output a response corresponding to a received input. For example, the device 100 may be configured to obtain or determine an inquiry indicated by a received input and output a response regarding the inquiry. The device 100 may, for example, select one response to output from among a plurality of responses corresponding to an inquiry based on a response level corresponding, for example, to a user level.

The device 100 may operate in conjunction with a server 110. For example, the device 100 may determine a response level using information regarding a user received from the server 110. For example, if a user is a preschooler, the device 100 may determine a response level to a preschooler level by using information regarding the user received from the server 110 and output a response at the preschooler level.

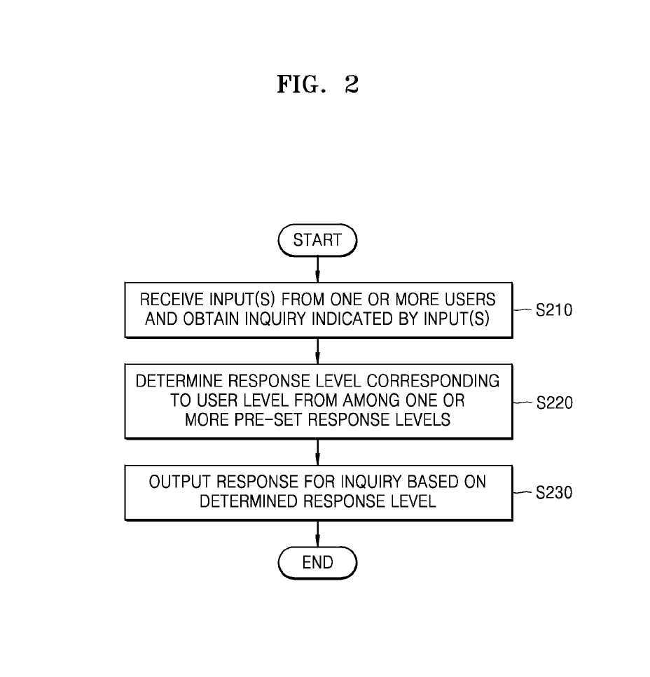

FIG. 2 is a flowchart illustrating an example method whereby the device 100 outputs a response regarding an inquiry.

In an operation S210, the device 100 may receive an input from one or more users and obtain or determine an inquiry indicated by the input.

The device 100 may receive a user input from outside of the device 100. For example, the device 100 may receive at least one selected from a touch input, a keyboard input, a voice input, a sound input, a button input, a gesture input, and a multimodal input.

The device 100 may receive inputs from a plurality of users. For example, the device 100 may receive inputs from a user group including a plurality of users. For example, the device 100 may receive voice inputs from a plurality of users via a sensor included in the device 100.

The device 100 may obtain or determine an inquiry indicated by a received input.

For example, the device 100 may extract a keyword from a received input and obtain or determine an inquiry indicated by the received input using the extracted keyword. For example, if the device 100 receives a text input “let us decide a restaurant and foods to order,” the device 100 may extract keywords “restaurant” and “order” and obtain an inquiry “what are foods offered by popular restaurants around a current location?”

In another example, if a received input corresponds to a pre-set input, the device 100 may obtain or determine an inquiry indicated by the pre-set input. For example, if a gesture input pointing out a particular object is received, the device 100 may obtain an inquiry “what is the pointed-out object?” In another example, if the device 100 receives a gesture input pointing out the sky, the device 100 may obtain an inquiry “how is today's weather?” In another example, if the device 100 receives a gesture input expressed using sign language, the device 100 may analyze an intention indicated by the sign language and obtain an inquiry indicated by the gesture input. In another example, if the device 100 receives a text input “time,” the device 100 may obtain an inquiry “what time is it now?”

In another example, the device 100 may obtain an inquiry indicated by a received input by using the received input and user information. User information may include at least one selected from information regarding location of a user, current time information, information regarding a history of responses to a user, information regarding age of a user, and information regarding knowledge level of a user. Information regarding a history of responses to a user may refer to information regarding histories of inputs and responses related to a current user. For example, if a number of times that an inquiry “what are foods offered by popular restaurants around a current location?” is obtained in relation to a current user is equal to or greater than a certain number of times, the inquiry “what are foods offered by popular restaurants around a current location?” may be obtained even if only a keyword “restaurant” is obtained from an input from the current user. For example, if a keyword obtained from a user input is “how to go to home,” the device 100 may obtain an inquiry “what is a phone number of a call taxi company?” may be obtained in an early morning time and may obtain an inquiry “what is a number of a bus line to go to home from a current location?” in an evening time.

In another example, the device 100 may obtain an inquiry indicated by a received input using the received input and user information regarding a plurality of users making up a user group. User information may include at least one selected from information regarding location of a user, current time information, information regarding a history of responses to a user, information regarding age of a user, and information regarding knowledge level of a user. Information regarding a history of responses to a user may refer to information regarding histories of inputs and responses related to a current user. When the device 100 outputs a response with respect to a user group, the device 100 may reflect preferences of users included in the user group. For example, if an inquiry is “where is a recommended place for a get-together?”, the device 100 may analyze information regarding users included in a user group and output a restaurant preferred by most of the users as a response. In another example, if an inquiry is “where is a recommended place for a get-together?”, the device 100 may output a restaurant with the most favorable evaluation from among restaurants determined as places for get-togethers in the past as a response.

If the device 100 fails to obtain or determine an inquiry corresponding to a received input, the device 100 may receive additional input from a user.

For example, if the device 100 fails to analyze a received input, the device 100 may display a screen image requesting an additional input. For example, if the device 100 fails to obtain a text from a received voice input, the device 100 may display a screen image requesting an additional input.

In another example, if there are a plurality of inquiries corresponding to a received input and priorities regarding the plurality of inquiries are equal, the device 100 may receive an additional input from a user to determine one inquiry corresponding to the received input.

If an additional input is received, the device 100 may obtain an inquiry based on the initially received input and the additional input.

For example, if a keyword obtained from the input initially received by the device 100 is “current” and a keyword obtained from the additional input is “time,” an inquiry “what time is it now?” may be obtained.

The device 100 may determine an input method. For example, the device 100 may determine an input method based on type of an input received from a user. The device 100 may determine a method of receiving a user input based on the input method.

For example, if the device 100 recognizes a sound from outside of the device 100, the device 100 may determine a sound input method as an input method. If the device 100 determines the sound input method as the input method, the device 100 may obtain an inquiry indicated by a sound input received via a microphone included in the device 100.

The device 100 may receive an input based on a determined input method. For example, if the device 100 determines a gesture input method as the input method, the device 100 may receive a gesture input from outside of the device 100 and obtain an inquiry indicated by the received gesture input.

In an operation S220, the device 100 may determine a response level corresponding to a user level from among one or more pre-set response levels.

The device 100 may store one or more pre-set response levels.

For example, the device 100 may store a plurality of response levels determined based on ages. For example, the device 100 may store response levels corresponding to ages from 3 to 100. In another example, the device 100 may store response levels categorized into preschooler, schoolchild, teenager, young adult, prime of life, and old.

In another example, the device 100 may store a plurality of response levels determined based on knowledge levels. For example, the device 100 may store response levels categorized into elementary school graduate, junior high school graduate, high school graduate, university graduate, master's degree, and doctoral degree. In another example, the device 100 may store response levels categorized into beginner, intermediate, advanced, and expert. In another example, the device 100 may store response levels categorized into non-specialist, specialist, and expert. In another example, the device 100 may store response levels corresponding to levels from 1 to 100, respectively.

The device 100 may determine a response level corresponding to a user level. For example, the device 100 may determine a response level based on at least one selected from age information and knowledge level information regarding a user.

For example, the device 100 may determine one from among response levels categorized into preschooler, schoolchild, teenager, young adult, prime of life, and old as a response level corresponding to a user level. For example, if a user input is a child's voice, the device 100 may analyze the voice and determine a child response level as a response level corresponding to a user level. The device 100 may determine age of a user by analyzing characteristics of a received voice input and determine a response level based on the determined age. For example, if characteristics of a received voice input correspond to characteristics of voice of a child, the device 100 may determine a child response level as a response level corresponding to the received voice input. The device 100 may obtain a text indicated by a voice from a received voice input and determine a response level by analyzing the obtained text. For example, if the obtained text includes childish words or childish expressions, the device 100 may determine a child response level as a response level corresponding to the received voice input.

In another example, the device 100 may determine one from among a plurality of pre-set response levels as a response level corresponding to a user level using age information or knowledge level information regarding a user, which is stored in the device 100 in advance or received from outside of the device 100. For example, the device 100 may receive information indicating that a knowledge level of a user applying an input corresponds to the expert level and determine a response level corresponding to the expert level as a response level appropriate for the user level.

The device 100 may determine a response level for each user based on data stored in the device 100. For example, if information regarding age or academic ability of a user is stored in the device 100, the device 100 may determine a response level corresponding to the age or the academic level of the user as a response level for the user.

The device 100 may determine a response level for each user based on inputs received from the user. For example, the device 100 may receive an input for determining level of a user from the user and determine a response level for the user. In another example, the device 100 may analyze an input received from a user and determine a response level for the user. For example, the device 100 may analyze voice tone of a user and determine age of the user or may analyze difficulty of vocabularies used by a user and determine knowledge level of the user.

The device 100 may provide a graphic user interface (GUI) for selecting a response level.

For example, the device 100 may receive an input for selecting a response level from a user via a GUI for selecting a number from 1 to 10.

In another example, the device 100 may receive an input for selecting a response level from a user by receiving an input for selecting one from among a plurality of images respectively indicating a plurality of response levels. For example, the device 100 may determine a child level as a response level if a character is selected and may determine an adult level as a response level if a landscape image is selected.

The device 100 may output a sample response that is anticipated to be output when a particular response level is selected from among a plurality of response levels. A user may refer to a sample response in case of applying an input for selecting one from among a plurality of response levels.

In an operation S230, the device 100 may output a response regarding an inquiry based on the response level determined in the operation S220.

The device 100 may determine one or more responses corresponding to the inquiry obtained in the operation S210. For example, the device 100 may obtain a plurality of responses corresponding to an inquiry “what movies are popular these days?” For example, the plurality of responses may correspond to a first movie popular with preschoolers, a second move popular with teenagers, and a third move popular with adults.

The device 100 may determine one response of one or more responses corresponding to the inquiry obtained in the operation S210. For example, the device 100 may determine one response from among responses including a first movie, a second movie, and a third movie corresponding to the inquiry “what movies are popular these days?” based on a user level.

The device 100 may obtain user information. User information may, for example, include at least one selected from information regarding location of a user, current time information, information regarding a history of responses to a user, information regarding age of a user, and information regarding knowledge level of a user. For example, the device 100 may store user information in advance. In another example, the device 100 may receive and store user information.

Information regarding a history of responses may include information regarding feedback provided by a user about responses provided to the user in the past. For example, if the device 100 receives a text “restaurant” from a user and outputs a restaurant A as an inquiry, the user may input a restaurant B in the form of a text as feedback information. For example, the device 100 may output a response later reflecting the feedback information “restaurant B” thereto. For example, the device 100 may output the restaurant B as a response when a same text “restaurant” is input later.

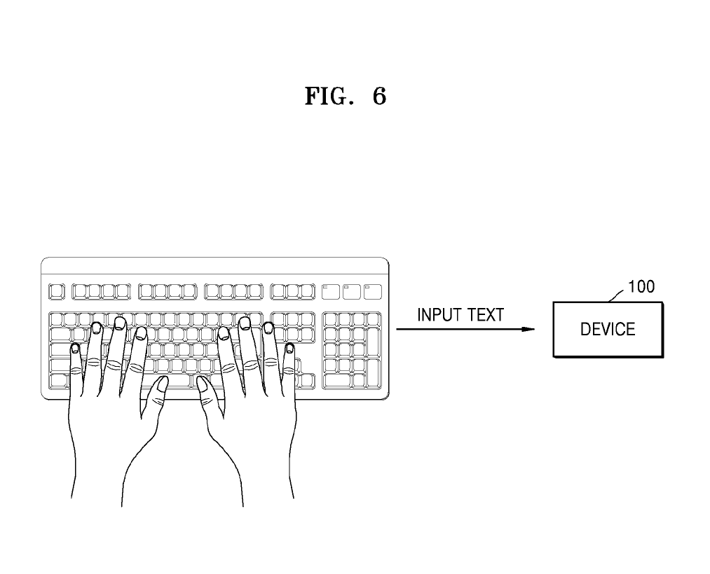

Feedback information may be input to the device 100 in various ways. For example, feedback information may be input to the device 100 via at least one selected from a text input, a gesture input, a voice input, a sketch input, and a multimodal input. More detailed descriptions thereof are discussed below with reference to FIGS. 6 to 11.

The device 100 may output one response of one or more responses corresponding to the inquiry obtained in the operation S210 based on at least one selected from the response level determined in the operation S220 and user information.

For example, the device 100 may determine one response from among responses including a first movie, a second movie, and a third movie corresponding to the inquiry “what movies are popular these days?” based on information regarding age of a user included in the user information.

The device 100 may output a determined response. For example, the device 100 may output a determined response as at least one selected from a text, a voice, an image, and a moving picture. For example, if a determined response is “17 o'clock,” the device 100 may display a text “17 o'clock,” may play back a voice saying “17 o'clock,” may display a clock image indicating “17 o'clock,” or display a clock animation indicating a current time.

The device 100 may output different responses with respect to a same inquiry and a same response level, based on circumstances. For example, the device 100 may first output a response “Seoul” with respect to a first inquiry “what is current location?” and may output a response “Dogok-dong, Seoul” with respect to a second inquiry “what is current location?” In another example, the device 100 may first output a response regarding today's weather with respect to a first inquiry “how is the weather?” and may output a response regarding this week's weather with respect to a second inquiry “how is the weather?”. For example, the device 100 may output different responses with respect to a same inquiry, based on a current time and/or a current location. For example, for a same inquiry “how to go to home” obtained from a same user, the device 100 may output a response “phone number of a call taxi company” in an early morning time and may output “a number of a bus line to go to home from a current location?” in an evening time.

The device 100 may output a same response with respect to a same inquiry and a same response level. For example, the device 100 may always output a current location to the street number level in correspondence to an inquiry “what is current location?”

The device 100 and the server 110 may operate in conjunction with each other. For example, the device 100 may upload information stored in the device 100 to the server 110. In another example, the device 100 may receive information from the server 110 and store the received information.

If the device 100 receives data from the server 110, the device 100 may store the received data according to categories. For example, data received from the server 110 may be categorized based on data storage categories set based on a user's input and may then be stored in the device 100.

The device 100 may transform data received from the server 110 into data in a simpler form compared to the form that the data is stored in the server 110 and store the transformed data. For example, a moving picture received by the device 100 from the server 110 may be converted to a format with higher compression efficiency.

In another example, the server 110 may transform data received from the device 100 into data in a more complicated form compared to the form that the data is stored in the device 100 and store the transformed data. For example, when the server 110 stores information regarding specialty of a user received from the device 100 in a user specialty information category, the server 110 may add related information stored in the server 110 to the received information and store the combined information.

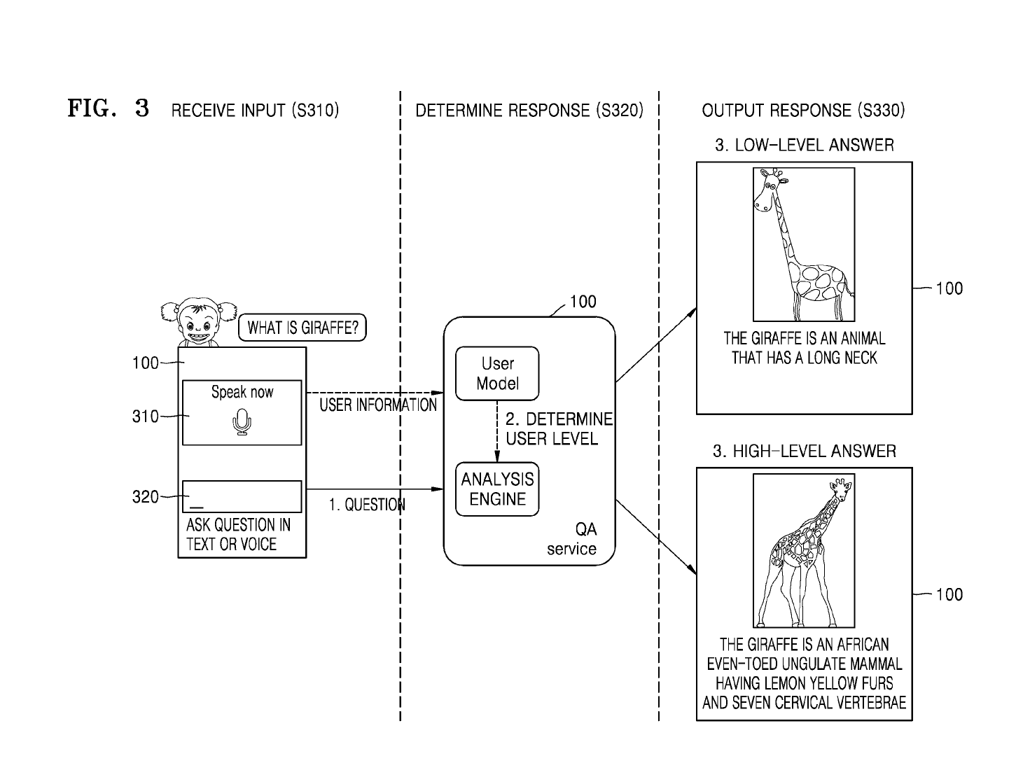

FIG. 3 is a diagram illustrating an example that the device 100 outputs one from among a plurality of responses for an inquiry.

In an operation S310, the device 100 may receive a user input. For example, the device 100 may display a screen image 310 requesting to apply a voice input and receive a voice input from a user. In another example, the device 100 may display a screen image 320 requesting to apply a text input and receive a text input from a user. For example, the device 100 may receive a voice input “what is giraffe?” from a user.

In an operation S320, the device 100 may determine a response to output. The device 100 may determine a response to output by using an inquiry and a user level indicated by a received user input. For example, the device 100 may obtain a plurality of responses corresponding to an inquiry indicated by a received user input by response levels. The device 100 may determine one response based on a response level corresponding to a user level. For example, in case of determining a response level corresponding to an inquiry “what is giraffe?”, the device 100 may determine a low response level when a user is a child and may determine a high response when the user is an adult.

In an operation S330, the device 100 may output a response determined in the operation S320. For example, the device 100 may output a determined response as at least one selected from a text, a voice, and an image. For example, if a determined response is information regarding a giraffe, the device 100 may display the information regarding a giraffe using an image and a text.

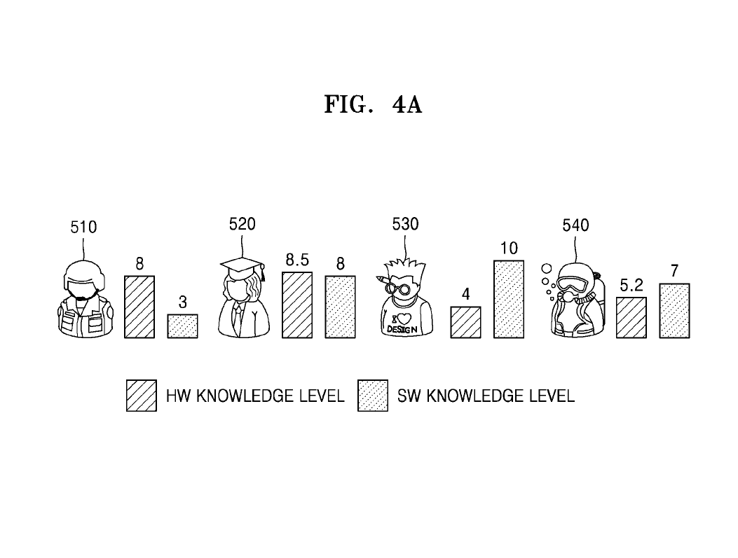

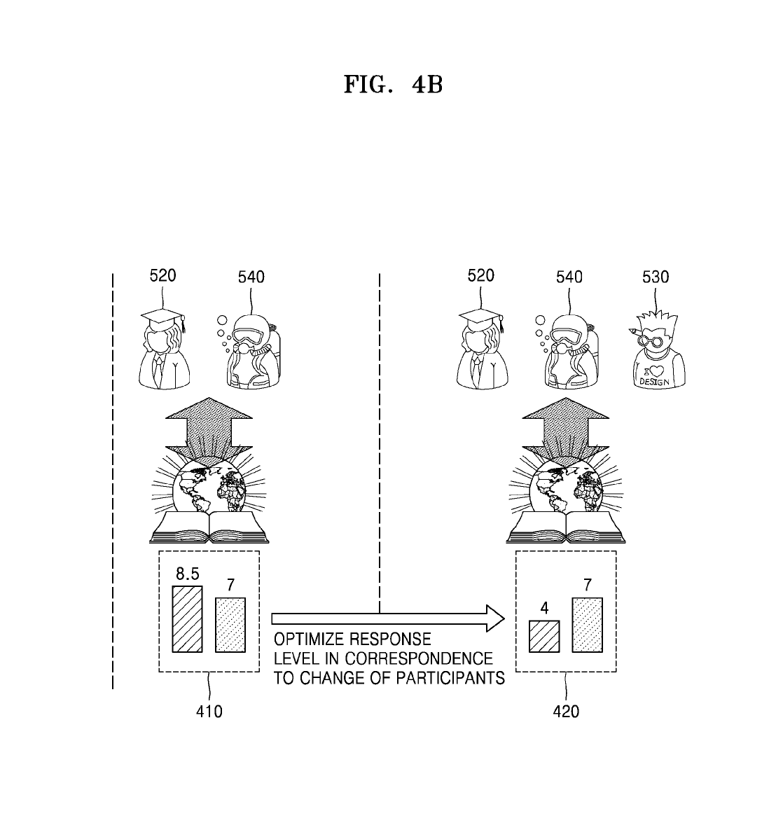

FIG. 4A is a diagram illustrating an example in which the device 100 may determine response levels with respect to a plurality of users, respectively.

For example, the device 100 may determine a HW knowledge level and a SW knowledge level for each of a plurality of users 510 to 540. Knowledge level categories are not limited to the HW knowledge level and the SW knowledge level, and the device 100 may indicate a knowledge level by using one or more categories.

The device 100 may determine a knowledge level of each user using a history of responses for a corresponding user. For example, if responses obtained based on user inputs received from the second user 520 include technical terms at a high frequency, the device 100 may determine a high knowledge level for the second user 520. In another example, if feedback information received from the second user 520 requests high response level, the device 100 may determine a high knowledge level for the second user 520.

The device 100 may obtain information regarding knowledge levels of respective users by receiving the information. For example, a user may input his or her knowledge level via a touch input.

The device 100 may determine a response level corresponding to a knowledge level determined for each user.

FIG. 4B is a diagram illustrating an example in which the device 100 determines a response level for a user group.

The device 100 may determine a response level for a user group. For example, the device 100 may determine a knowledge level 410 for a first user group including the second user 520 and the fourth user 540. The knowledge level of the first user group may be determined based on knowledge levels of the users included in the first user group. For example, an average of the knowledge levels of the users of the first user group may be determined as the knowledge level of the first user group. In another example, knowledge level of a user with the lowest knowledge level from among the users included in the first user group may be determined as the knowledge level of the first user group. If a second user group is formed by adding the third user 530 to the first user group, knowledge level 420 of the second user group may be changed by reflecting knowledge level of the newly added user.

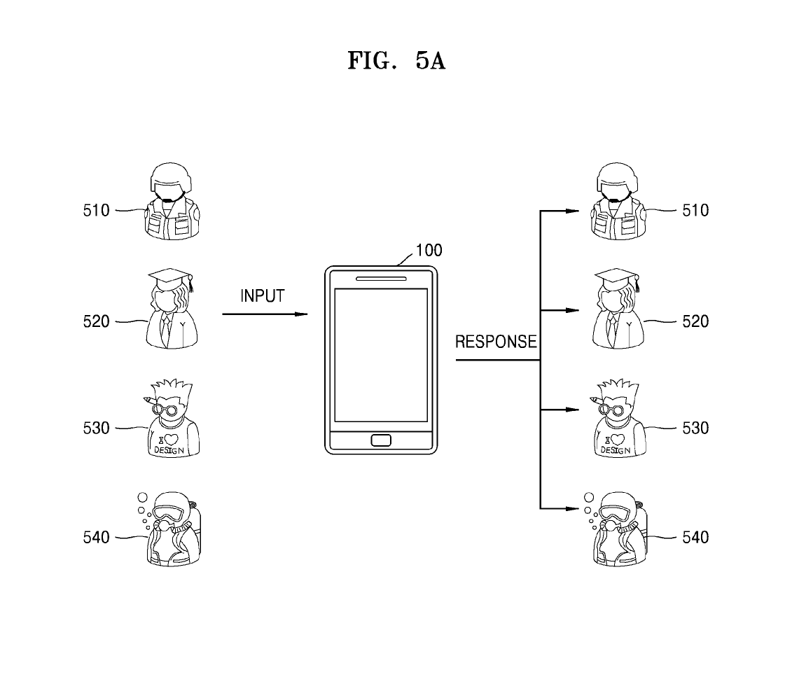

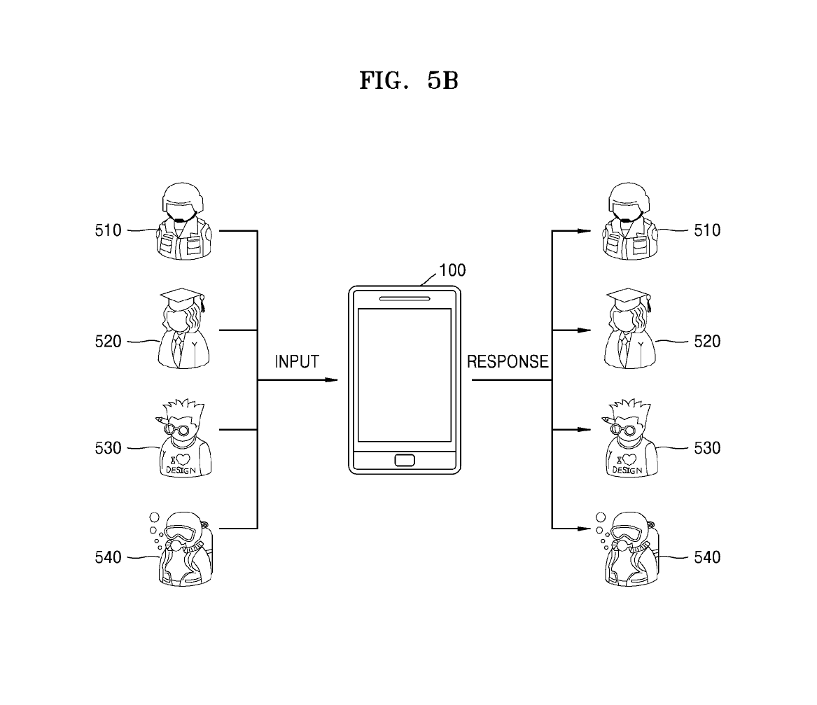

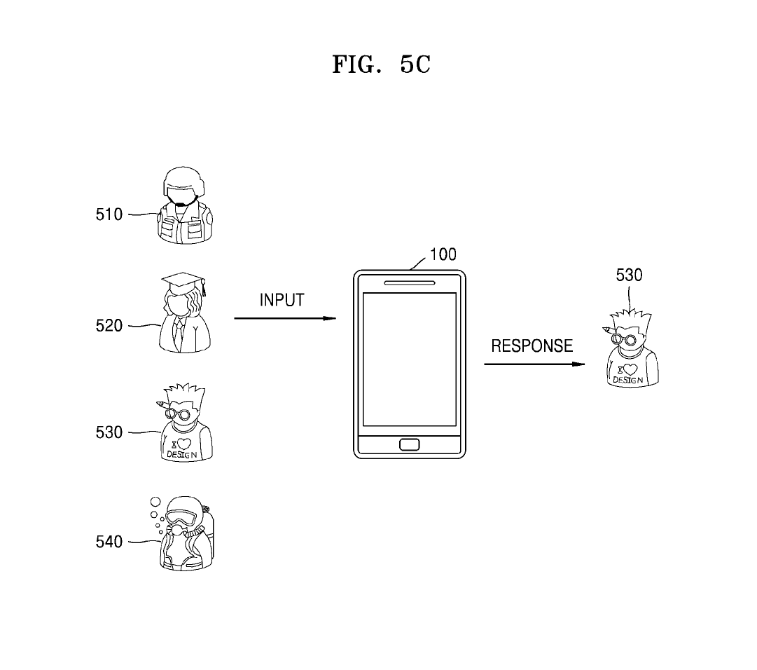

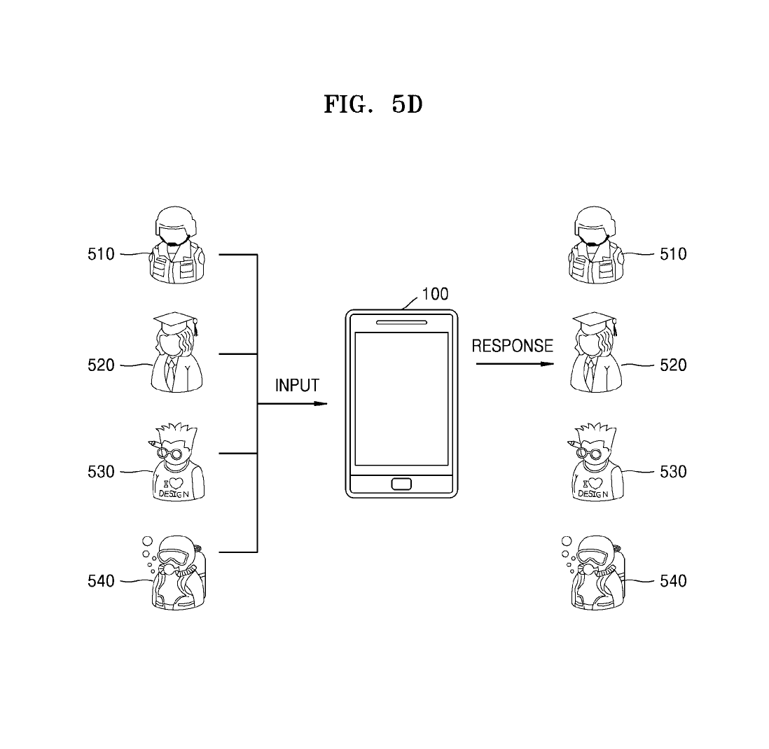

FIG. 5A is a diagram illustrating an example in which the device 100 provides a response corresponding to an input received from any one user from among a plurality of users to the plurality of users based on a user level of the any one user.

For example, the device 100 may determine a response level in based on a user level of the second user 520 from among the first to fourth users 510 to 540. Furthermore, the device 100 may provide a response corresponding to a response level determined based on the user level of the second user 520 from among one or more responses corresponding to an input received from the second user 520 to the first to fourth users 510 to 540.

The device 100 may provide a response in the form of a B2C (Business-to-customer) group. For example, the device 100 may provide a response corresponding to a response level determined based on knowledge level of a single user to a plurality of users.

FIG. 5B is a diagram illustrating an example in which the device 100 provides a response corresponding to inputs received from a plurality of users based on user levels of the plurality of users.

For example, the device 100 may determine a response level based on user levels of the first to fourth users 510 to 540. Furthermore, the device 100 may provide a response corresponding to a response level determined based on the user levels of the first to fourth users 510 to 540 from among one or more responses corresponding to inputs received from the first to fourth users 510 to 540 to the first to fourth users 510 to 540.

The device 100 may provide a response in the form of a B2B (Business-to-business) group. For example, the device 100 may provide a response corresponding to a response level determined based on knowledge level of a plurality of users to the plurality of users.

For example, if a first device (not shown), a second device (not shown), a third device (not shown), and a fourth device (not shown) that operate in conjunction with the device 100 provide outputs respectively to the first user 510, the second user 520, the third user 530, and the fourth user 540, the device 100 may obtain or determine an inquiry indicated by inputs received from the first to fourth users 510 to 540, and the first through fourth devices may output responses corresponding to the obtained inquiry at different response levels based on user levels of the respective users. For example, if the third user 530 is not ready enough for a topic, the third user 530 may input a low response level to the third device and receive a low level response via the third device. In another example, if knowledge level of the second user 520 is high, the second device may confirm that knowledge level of the second user 520 is high based on a history of responses to the second user 520 and provide a high level response to the second user 520.

In another example, the device 100 may obtain an inquiry indicated by inputs received from the first to fourth users 510 to 540 and output a response corresponding to the response based on knowledge levels of all of the first to fourth users 510 to 540. For example, the device 100 may determine a response level based on a knowledge level of a user with the lowest knowledge level from among the first to fourth users 510 to 540. In another example, the device 100 may determine a response level based on an average knowledge level of the first to fourth users 510 to 540.

FIG. 5C is a diagram illustrating an example in which the device 100 provides a response corresponding to an input received from any one user from among a plurality of users based on a user level of any one user.

For example, the device 100 may determine a response level based on a user level of the second user 520 from among the first to fourth users 510 to 540. Furthermore, the device 100 may provide a response corresponding to a response level determined based on the user level of the second user 520 from among one or more responses corresponding to an input received from the second user 520 to the third user 530.

The device 100 may provide a response in the form of a B2C individual. For example, the device 100 may provide a response corresponding to a response level determined based on knowledge level of a single user to the single user.

FIG. 5D is a diagram illustrating an example in which the device 100 provides a response corresponding to inputs received from a plurality of users to a particular user based on user levels of the plurality of users.

For example, the device 100 may determine a response level based on user levels of the first to fourth users 510 to 540. Furthermore, the device 100 may provide a response corresponding to a response level determined based on user levels of the first to fourth users 510 to 540 from among one or more responses corresponding to inputs received from the first to fourth users 510 to 540 to the second user 520.

The device 100 may provide a response in the form of a B2B individual. For example, the device 100 may provide a response corresponding to a response level determined based on knowledge level of a plurality of users to a single user.

FIG. 6 is a diagram illustrating an example in which the device 100 receives a text input.

The device 100 may receive an input from outside of the device 100. For example, the device 100 may receive a user input via a keyboard. In case of receiving a user input via a keyboard, the received user input may be a text.

If the device 100 receives a text input, an inquiry indicated by the text input may be obtained. For example, the device 100 may extract a keyword from a received text input and obtain an inquiry indicated by the received text input using the extracted keyword. For example, if a received text is “I am hungry now,” the device 100 may extract a keyword “hungry” and obtain an inquiry “what is a popular restaurant around a current location?”

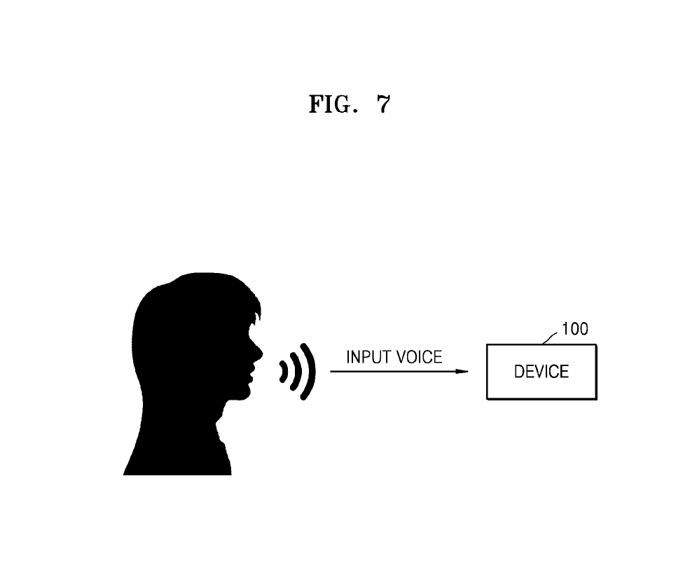

FIG. 7 is a diagram illustrating an example in which the device 100 receives a voice input.

The device 100 may receive an input from outside of the device 100. For example, the device 100 may receive a user input in the form of a sound input. In case of receiving a user input in the form of a sound input, the device 100 may receive a user input via a microphone (not shown) included in the device 100.

If the device 100 receives a voice input, an inquiry indicated by the voice input may be obtained. For example, the device 100 may convert the received voice input to a text, extract a keyword from the converted text, and obtain an inquiry indicated by the received input using the extracted keyword.

If the device 100 receives a voice input, the device 100 may obtain information regarding a user by analyzing characteristics of the voice input. For example, if it is determined as a result of analyzing a received voice input that the received voice input includes characteristics of a child's voice, the device 100 may determine an age of a user as a child age.

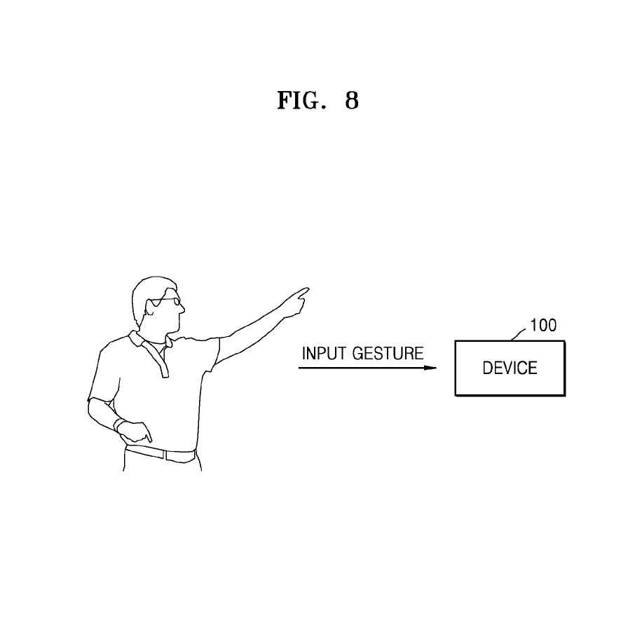

FIG. 8 is a diagram illustrating an example in which the device 100 receives a gesture input.

The device 100 may receive a gesture input from outside of the device 100. For example, the device 100 may obtain information regarding a motion detected from outside the device 100.

For example, the device 100 may recognize a motion such as a user pointing out a particular object. For example, if the device 100 recognized a motion that a user points out a particular object, an inquiry “what is the pointed-out object?” may be obtained. In another example, the device 100 may recognize a motion that a user folds his or her arms. In this case, for example, the device 100 may obtain an inquiry “what time is it now?” as an inquiry corresponding to the motion that the user folds his or her arms. The device 100 may determine and store inquiries corresponding to respective motions in advance.

The device 100 may, for example, receive a gesture input via a motion detecting sensor or a camera.

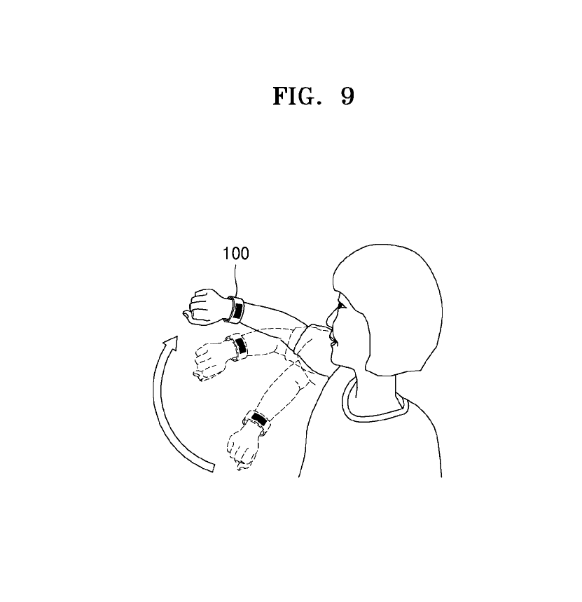

FIG. 9 is a diagram illustrating an example in which the device 100 includes a wearable device.

The device 100 may, for example, be a wearable device. For example, the device 100 may be in the form of a wristwatch, an eyeglass, an earring, a necklace, an earphone, an earring-type accessory, a shoe, a ring, a cloth, or a helmet, or the like. However, the disclosure is not limited thereto, and the device 100 may, for example, be directly attached to and detached from a user's body. For example, the device 100 may be embodied in the form of a patch and may be adhesively or non-adhesively attached to and detached from a user's body. Furthermore, the device 100 may be inserted in a user's body. For example, the device 100 may be in the form of an epidermal electronics (or E-Skin) or an electronic tattoo (E-Tattoo) and may be inserted to the epidermis or in a human body via a medical surgery.

When a user wears the device 100, the device 100 may contact the user's body. For example, the device 100 may wear the device 100 like wearing a wristwatch on his or her wrist, wearing an eyeglass, wearing an earring, wearing a necklace, putting an earphone into an ear, putting an earring-type accessory on an earflap, wearing a shoe, wearing a ring on a finger, wearing a cloth, or wearing a helmet, or the like.

If the device 100 is a wearable device, the device 100 may receive an input regarding a motion applied by a user to the device 100 to apply an input to the device 100. For example, if location of the device 100 is changed, the device 100 may obtain gesture information based on information regarding a movement of the device 100. For example, if the device 100 is moved to a location at a height corresponding to eyes of a user, the device 100 may obtain an inquiry “what time is it now?”

The device 100 may receive, for example, a gesture input by using a gyro sensor, a geomagnetic sensor, an acceleration sensor, a camera, a tilt sensor, or a gravity sensor, or the like.

If the device 100 is a wearable device, the device 100 may exchange data with an external device using, for example, a Bluetooth protocol and/or a Wi-Fi protocol, or the like.

If the device 100 is a wearable device, the device 100 may receive an input by, for example, recognizing blinking of eyes, recognizing a voice, or recognizing a virtual keyboard, or the like.

If the device 100 is a wearable device, the device 100 may output a response by, for example, displaying the response on a display screen or outputting the response as a voice.

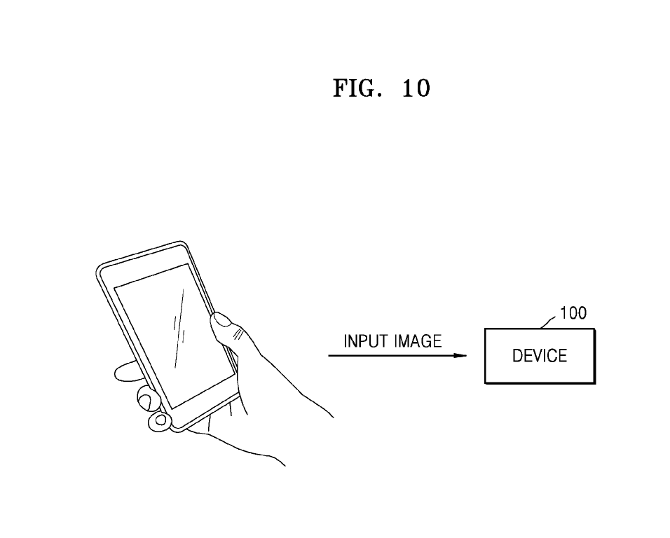

FIG. 10 is a diagram illustrating an example in which the device 100 receives an image input.

The device 100 may receive an image input. If the device 100 receives an image input, the device 100 may receive an input using a light detecting sensor, such as, for example, a camera, included in the device 100.

If the device 100 receives an image input, the device 100 may obtain an inquiry indicated by the received image input. For example, if a received image is a barcode, the device 100 may obtain an inquiry “what is information regarding an object corresponding to the barcode?” In another example, if a received image is an image of the sky, the device 100 may obtain an inquiry “how is today's weather?” In another example, if a received image is an image of an object A, the device 100 may obtain an inquiry “what is the object A?”

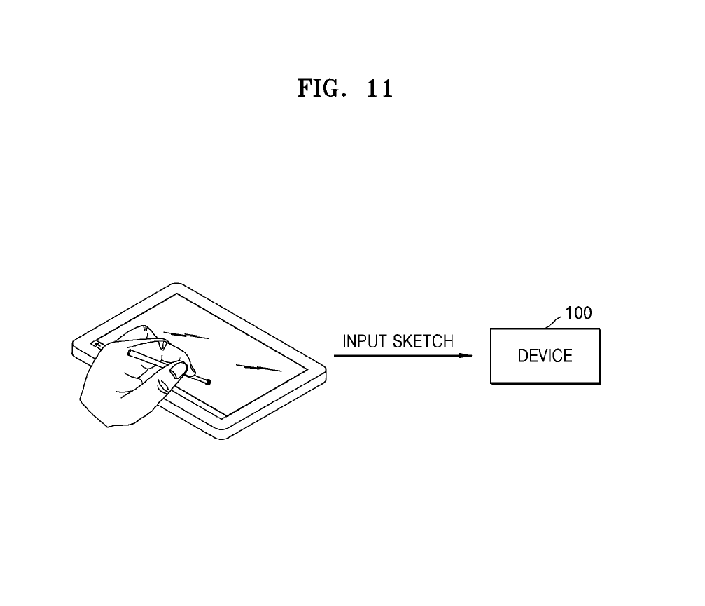

FIG. 11 is a diagram illustrating an example in which the device 100 receives a sketch input or a touch input.

The device 100 may receive a sketch input or a touch input. When the device 100 receives a touch input, the device 100 may, for example, receive an input using a touch sensor included in the device 100.

If the device 100 receives a sketch input, the device 100 may obtain an inquiry indicated by the received sketch input. For example, if a received sketch is a sketch of a star, the device 100 may obtain an inquiry “what are constellations that can be observed at a current location?” In another example, if a received sketch is a sketch of a certain object, the device 100 may obtain an inquiry “what is the particular object?” In another example, if a received sketch indicates a text, the device 100 may obtain an inquiry indicated by the text indicated by the sketch.

If the device 100 receives a touch input, the device 100 may obtain an inquiry indicated by the received touch input. For example, if a certain location on a display screen is successively touched for 3 times within a certain time period, the device 100 may obtain an inquiry “what is today's schedule?”

The device 100 may receive a multimodal input. For example, the device 100 may receive a voice input and a gesture input simultaneously. For example, a user may apply a gesture input for pointing out a particular object and a voice input to the device 100 simultaneously.

If a multimodal input is received, the device 100 may analyze a plurality of received inputs and output a response corresponding to the multimodal input. For example, if the device 100 receives a gesture input for pointing out a desk and a voice input “brand,” the device 100 may output brand name of the pointed-out desk based on a response level of a user.

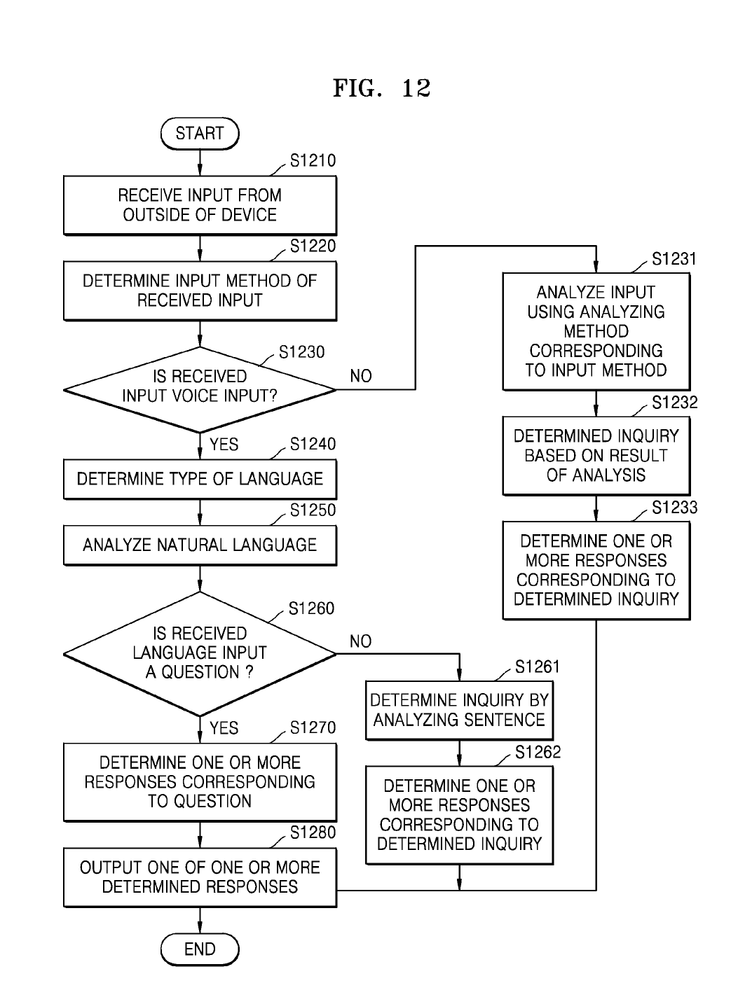

FIG. 12 is a flowchart illustrating an example method in which the device 100 outputs a response based on whether a received input is a language input.

In an operation S1210, the device 100 may receive inputs from outside of the device 100. Inputs received by the device 100 may include user inputs. User inputs may include at least one selected from a touch input, a keyboard input, a voice input, a sound input, a button input, a gesture input, and a multimodal input.

In an operation S1220, the device 100 may determine an input method of the received input. For example, if a received input is a voice input, the device 100 may determine the input method of the received input as voice input. The device 100 may process a user input based on a determined input method.

In an operation S1230, the device 100 may determine whether a received input is a language input. For example, if a received input is a text input based on Korean, the device 100 may determine the received input as a language input. In another example, if a received input is sound of hand clapping, the device 100 may determine that the received input is not a language input. In another example, the device 100 may determine that a received input includes two or more languages.

In an operation S1231, if a received input is not a language input, the device 100 may analyze the received input using an analyzing method corresponding to an input method. For example, if an input is a sound of hands being clapped once, the device 100 may analyze a received input signal and determine that the user input is the sound of hands being clapped once.

In an operation S1232, the device 100 may determine an inquiry indicated by a user input based on a result of an analysis performed in the operation S1231. For example, if it is determined as a result of an analysis performed in the operation S1231 that the user input is sound of clapping hands once, the device 100 may obtain an inquiry that is determined in advance to correspond to sound of clapping hands once. For example, as determined in advance, the device 100 may correspond an inquiry “what time is it now?” to sound of clapping hands once.

In an operation S1233, the device 100 may determine one or more responses corresponding to an inquiry determined in the operation S1232. For example, if an inquiry determined in the operation S1232 is “what is giraffe?”, the device 100 may determine a response for providing information regarding the giraffe to a preschooler, a response for providing information regarding the giraffe to a normal person, and a response for providing information regarding the giraffe to an expert from among responses stored in the device 100 as responses corresponding to the inquiry.

In an operation S1240, if a received input is a language input, the device 100 may determine type of a language. For example, if a received input is a voice input, the device 100 may analyze the voice and determine type of a language.

In an operation S1250, the device 100 may perform a natural language analysis with respect to a received input. For example, the device 100 may determine keywords, a sentence structure, and the subject of a sentence included in a received input.

In an operation S1260, the device 100 may determine whether a received input is a question. For example, the device 100 may determine whether a received input is a question using a result of an analysis performed in the operation S1250.

In an operation S1261, since a received input is not a question, the device 100 may analyze a received language input and determine an inquiry indicated by the user input.

In an operation S1262, the device 100 may determine one or more responses corresponding to an inquiry determined in the operation S1261. The description of the operation S1233 given above may be referred to for a description of a method of determining one or more responses.

In an operation S1270, since a received input is a question, the device 100 may determine the received language input as an inquiry and may determine one or more responses corresponding to the inquiry. The description of the operation S1233 given above may be referred to for a description of a method of determining one or more responses.

In an operation S1280, the device 100 may output one response from among one or more responses determined in the operation S1233, the operation S1262, or the operation S1270. The description of the operation S230 given above may be referred to for a description of a method of outputting one response from among one or more responses.

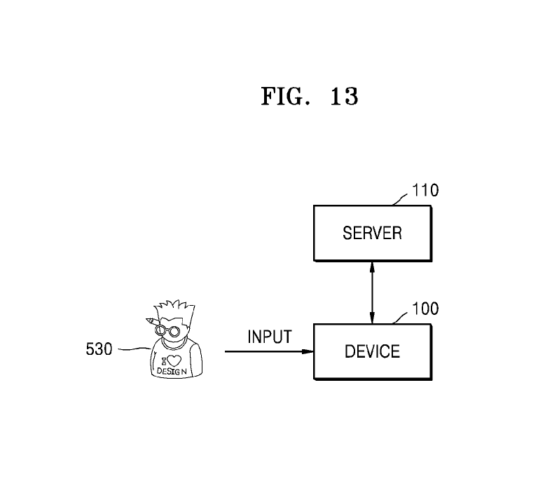

FIG. 13 is a diagram illustrating an example in which the device 100 models a user.

The device 100 may model a user. For example, the device 100 may determine response levels for respective users using information regarding the respective users. For example, the device 100 may model a third user 530 as a design specialist with a Master's degree in his/her 20s using information regarding the third user 530.

When the device 100 models a user, the device 100 may use various information regarding the user. For example, the device 100 may model a user using information regarding knowledge level of the user, experience level of the user, comprehension level of the user, career of the user, age of the user, position of the user, region of the user, search history of the user, SNS activity of the user, user profile of the user, feedback of the user, etc. The device 100 may categorize information regarding a user into variable information and non-variable information.

A user may apply a user input requesting re-adjustment of a response level regarding an output response to the device 100. Feedback information of a user may, for example, include a user input for requesting re-adjustment of a response level.

The device 100 may determine response levels for respective users using results of modeling the respective users.

The server 110 may model a user. For example, the server 110 may model a third user 530 as a design specialist with a Master's degree in his/her 20s using information regarding the third user 530.

When the server 110 models a user, the server 110 may use various information regarding the user. For example, the server 110 may model a user using information regarding knowledge level of the user, experience level of the user, comprehension level of the user, career of the user, age of the user, position of the user, region of the user, search history of the user, SNS activity of the user, user profile of the user, feedback of the user, etc. The server 110 may categorize information regarding a user into variable information and non-variable information.

The server 110 may receive a user input for requesting re-adjustment of a response level regarding an output response via the device 100. Feedback information of a user may include a user input requesting re-adjustment of a response level. Feedback information according to an embodiment may be transmitted to the server 110 via the device 100.

The server 110 may determine response levels for respective users using results of modeling the respective users.

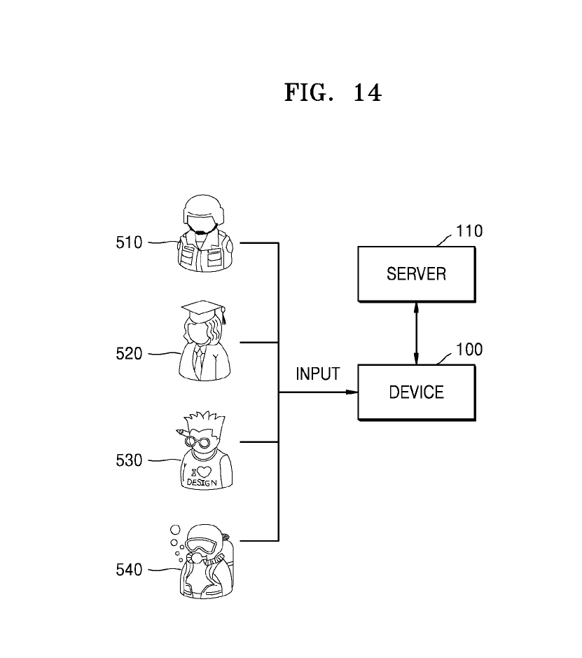

FIG. 14 is a diagram illustrating an example in which the device 100 models a user group including a plurality of users.

The device 100 may model a user group including a plurality of users. For example, the device 100 may determine a response level regarding a user group including users using information regarding the respective users. For example, the device 100 may model a user group based on similarities and differences between users making up the user group. For example, if 75% of users of a user group are interested in design, 100% of the users of the user group enjoy watching movies, 100% of the users of the user group are in their 30s, and 25% of the users of the user group have Bachelor's degrees, the device 100 may model the user group as a group of people who are in their 30s and are interested in design and movies.

When the device 100 models a user group, the device 100 may use various information regarding users included in the user group. For example, the device 100 may model a user using information regarding knowledge levels of the users, experience levels of the users, comprehension levels of the users, careers of the users, ages of the users, positions of the users, regions of the users, search histories of the users, SNS activities of the users, user profiles of the users, feedbacks of the users, etc. The device 100 may categorize information regarding users into variable information and non-variable information.

Users may apply user inputs requesting re-adjustment of a response level regarding an output response to the device 100. Feedback information of users may include user inputs requesting re-adjustment of a response level.

The device 100 may determine a response level regarding a user group using a result of modeling the user group.

The server 110 may model a user group including a plurality of users. For example, the server 110 may determine a response level regarding a user group including users using information regarding the respective users. For example, the server 110 may model a user group based on similarities and differences between users included in the user group. For example, if 75% of users of a user group are interested in design, 100% of the users of the user group enjoy watching movies, 100% of the users of the user group are in their 30s, and 25% of the users of the user group have Bachelor's degrees, the server 110 may model the user group as a group of people who are in their 30s and are interested in design and movies.

When the server 110 models a user group, the server 110 may use various information regarding users included in the user group. For example, the server 110 may model a user using information regarding knowledge levels of the users, experience levels of the users, comprehension levels of the users, careers of the users, ages of the users, positions of the users, regions of the users, search histories of the users, SNS activities of the users, user profiles of the users, feedbacks of the users, etc. The server 110 may categorize information regarding users into variable information and non-variable information.

Users may apply user inputs requesting re-adjustment of a response level regarding an output response to the device 100. Feedback information of users according to an embodiment may include user inputs requesting re-adjustment of a response level. Feedback information of users may be transmitted to the server 110 via the device 100.

The server 110 may determine a response level regarding a user group using a result of modeling the user group.

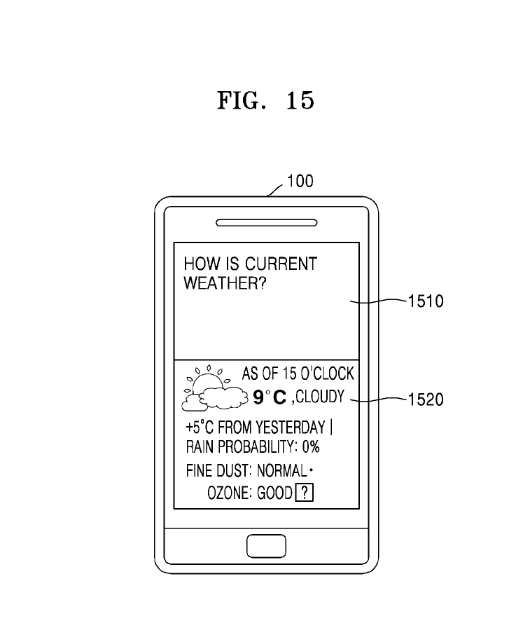

FIG. 15 is a diagram illustrating an example in which the device 100 displays an input and an output in a split screen image.

The device 100 may display an inquiry and a response by splitting a screen image.

For example, the device 100 may display an inquiry indicated by a user input in a first split screen image 1510 displayed on a part of a display screen of the device 100. For example, if a voice input received by the device 100 is “weather,” the device 100 may obtain an inquiry “how is current weather?” as an inquiry corresponding to the voice input and display the obtained inquiry in the first split screen image 1510. The device 100 may determine a response level corresponding to a user level from among one or more pre-set response levels and output a response based on the determined response level. For example, if a user level is determined to be an adult level, the device 100 may display a current weather in a format corresponding to the adult level in a second split screen image 1520.

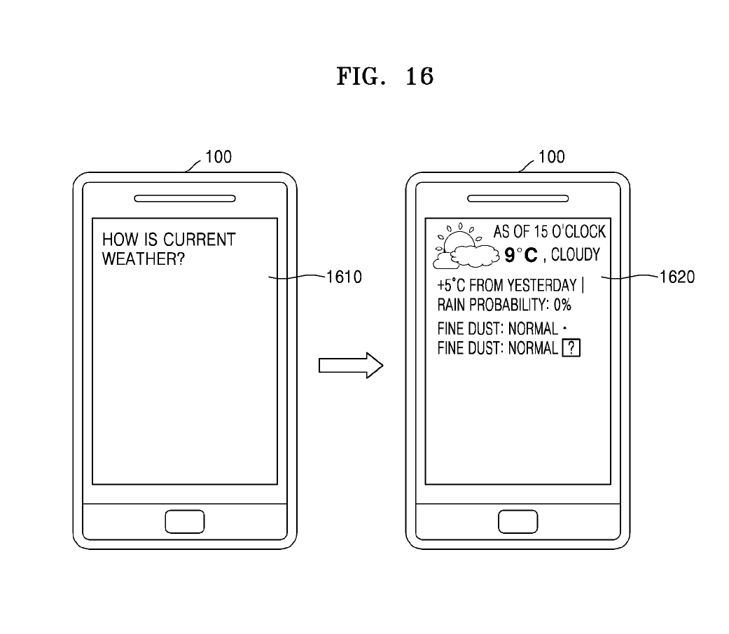

FIG. 16 is a diagram illustrating an example in which the device 100 displays an input and an output by switching screen images.

The device 100 may display an inquiry and a response by switching screen images.

For example, the device 100 may display an inquiry indicated by a user input in a first display screen image 1610 of the device 100. For example, if a gesture received by the device 100 is a gesture for pointing out the sky, the device 100 may obtain an inquiry “how is current weather?” as an inquiry corresponding to the gesture input and display the obtained inquiry in the first display screen image 1610. The device 100 may determine a response level corresponding to a user level from among one or more pre-set response levels and output a response based on the determined response level. For example, if a user level is determined to be an adult level, the device 100 may display a current weather in a format corresponding to the adult level in a second display screen image 1620. The first display screen image 1610 and the second display screen image 1620 may refer to screen images that are switched on a same display screen of the device 100 after a certain period of time. For example, after displaying of the first display screen image 1610 is completed, the second display screen image 1620 may be displayed.

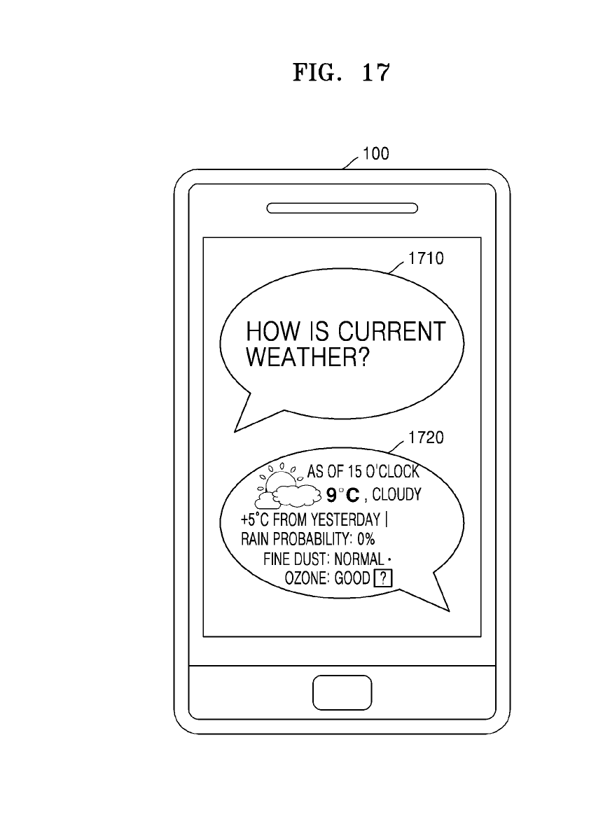

FIG. 17 is a diagram illustrating an example in which the device 100 displays an input and an output using speech balloons.

The device 100 may display an inquiry and a response by using speech balloons.

For example, the device 100 may display an inquiry indicated by a user input in a first speech balloon 1710 displayed on a part of a display screen of the device 100. For example, if a text input received by the device 100 is “weather,” the device 100 may obtain an inquiry “how is current weather?” as an inquiry corresponding to the text input and display the obtained inquiry in the first speech balloon 1710. The device 100 may determine a response level corresponding to a user level from among one or more pre-set response levels and output a response based on the determined response level. For example, if a user level is determined to be an adult level, the device 100 may display a current weather in a format corresponding to the adult level in a second speech balloon 1720.

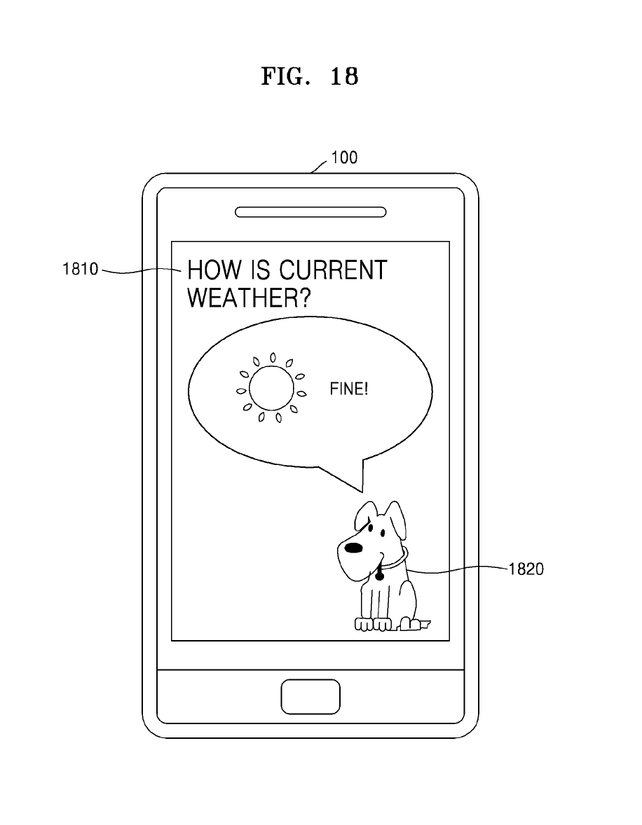

FIG. 18 is a diagram illustrating an example in which the device 100 displays an input and an output using an avatar.

The device 100 may display an inquiry and a response using an avatar.

For example, the device 100 may display an inquiry 1810 indicated by a user input on a display screen of the device 100. For example, if a text input received by the device 100 is “weather,” the device 100 may obtain the inquiry 1810 “how is current weather?” as an inquiry corresponding to the text input and display the obtained inquiry 1810. The device 100 may determine a response level corresponding to a user level from among one or more pre-set response levels and output a response based on the determined response level. For example, if a user level is determined to be a child level, the device 100 may display a current weather in a format corresponding to the child level using an avatar 1820.

The device 100 may provide a response via a message and/or an e-mail. For example, the device 100 may output a response in the form of a message. In another example, the device 100 may transmit an e-mail including a response to a user.

The device 100 may be provided as a wearable device. For example, the device 100 may be an eyeglass type device. If the device 100 is an eyeglass type device, the device 100 may provide a response by displaying the response on a display screen of the eyeglass type device.

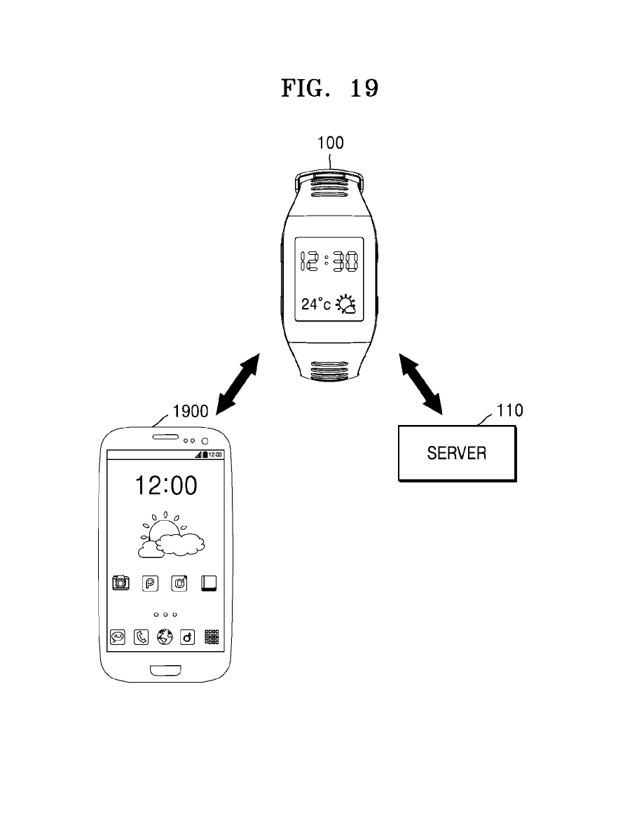

FIG. 19 is a diagram illustrating an example in which the device 100 operates in conjunction with the server 110 or another device 1900.

The device 100 may operate in conjunction with the other device 1900. For example, the device 100 may be a wearable device, whereas the other device 1900 may be a mobile device.

Referring to FIG. 19, the device 100 may be connected to at least one selected from the mobile device 1900 and a server for communication via a network. The network may, for example, include a local Area Network (LAN), a wide area network (WAN), a value added network (VAN), a mobile radio communication network, a satellite communication network, and a combination thereof, may be a data communication network, in a broad meaning thereof that enables smooth communications between respective network components illustrated in FIG. 19, and may include a wired internet, a wireless internet, and a mobile wireless communication network, or the like.

Furthermore, the device 100 may be a device with a relatively poor processing capability. Therefore, the device 100 may perform a particular function based on a circumstance of a user utilizing processing capabilities of the mobile device 1900 and/or the server 110. For example, the device 100 may display information regarding a schedule stored in the mobile device 1900 as a response for gesture information received from the device 100.

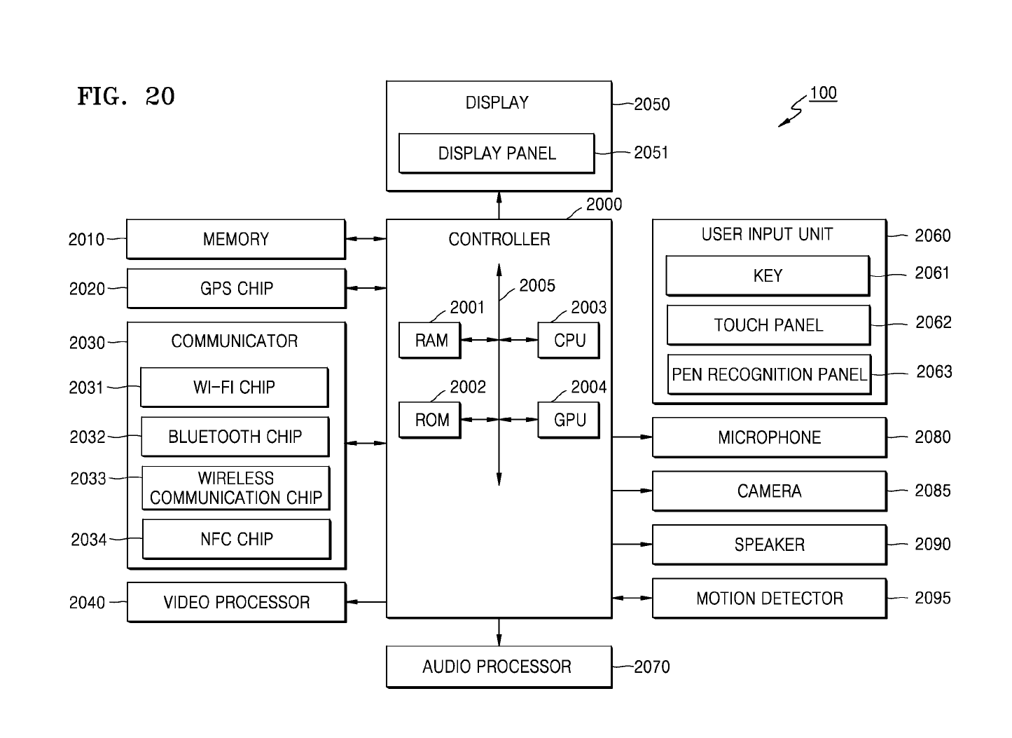

FIG. 20 is a block diagram illustrating an example configuration of the device 100.

Referring to FIG. 20, the device 100 may include at least one selected from a display 2050, a controller 2000, a memory 2010, a (global positioning system) GPS chip 2020, a communicator (e.g., communication circuitry) 2030, a video processor 2040, an audio processor 2070, a user input unit (e.g., including various input circuitry) 2060, a microphone 2080, an camera 2085, a speaker 2090, and a motion detector 2095.

The display 2050 may include a display panel 2051 and a controller (not shown) for controlling the display panel 2051. The display panel 2051 may be various types of display panels, such as a liquid crystal display (LCD) panel, an organic light emitting diode (OLED) panel, an active-matrix OLED (AM-OLED), and a plasma display panel (PDP), or the like. The display panel 2051 may be flexible, transparent, or wearable. The display 2050 may be combined with a touch panel 2062 of the user input unit 2060 and provided as a touch screen (not shown). For example, a touch screen (not shown) may include an integrated module in which the display panel 2051 and the touch panel 2062 may be combined with each other in a stacked structure.

The memory 2010 may include at least one selected from an internal memory (not shown) and an external memory (not shown).

An internal memory may include at least one selected from a volatile memory (e.g., a dynamic RAM (DRAM), a static RAM (SRAM), a synchronous dynamic RAM (SDRAM), etc.), a non-volatile memory (e.g., an one time programmable ROM (OTPROM), a programmable ROM (PROM), an erasable and programmable ROM (EPROM), an electrically erasable and programmable ROM (EEPROM), a mask ROM, a flash ROM, etc.), a hard disk drive (HDD), and a solid state drive (SSD), or the like. The controller 2000 may be configured to load a received instruction or received data from at least one selected from a non-volatile memory or other components to a volatile memory and process the instruction or the data loaded on the volatile memory. Furthermore, the controller 2000 may be configured to store data received from or generated by other components in a non-volatile memory.

An external memory may include at least one selected from a compact flash (CF), a secure digital (SD), a micro secure digital (Micro-SD), a mini secure digital (Mini-SD), an extreme digital (xD), and a memory stick, or the like.

The memory 2010 may store various programs and data used for operations of the device 100. For example, the memory 2010 may temporarily or permanently store at least some of contents to be displayed on a lock screen image.

For example, the controller 2000 may be configured to control the display 2050 to display a portion of content stored in the memory 2010 on the display 2050. For example, the controller 2000 may be configured to display a portion of content stored in the memory 2010 on the display 2050. Furthermore, when a user performs a gesture with respect to a region of the display 2050, the controller 2000 may be configured to control an operation corresponding to the gesture of the user.

The controller 2000 may, for example, include at least one selected from a RAM 2001, a ROM 2002, a CPU 2003, a graphic processing unit (GPU) 2004, and a bus 2005. The RAM 2001, the ROM 2002, the CPU 2003, and the GPU 2004 may be connected to one another via the bus 2005.

The CPU 2003 accesses the memory 2010 and performs a booting operation by using an OS stored in the memory 2010. The CPU 2003 performs various operations by using various programs, contents, and data stored in the memory 2010.

A command set for booting a system may be stored in the ROM 2002, for example. For example, when a turn-on instruction is input and power is supplied, the CPU 2003 may copy an OS stored in the memory 2010 to the RAM 2001 according to instructions stored in the ROM 2002 and execute the OS, thereby booting the system. If booting is complete, the CPU 2003 copies various programs stored in the memory 2010 to the RAM 2001 and execute the programs copied to the RAM 2001, thereby performing various operations. When the device 100 is booted, the GPU 2004 displays a UI screen image at a region of the display 2050. For example, the GPU 2004 may generate a screen image in which an electronic document including various objects, such as contents, icons, and menus, is displayed. The GPU 2004 calculates property values, such as coordinates, shapes, sizes, and colors of respective objects to be displayed, according to layouts of a screen image. The GPU 2004 may generate screen images of various layouts including the respective objects based on the calculated property values. Screen images generated by the GPU 2004 are provided to the display 2050 and may be displayed at regions of the display 2050.

The GPS chip 2020 may receive GPS signals from GPS satellites and determine a current location of the device 100. The controller 2000 may be configured to determine a location of a user using the GPS chip 2020 in case of using a navigation application or in cases where a current location of the user is necessary.

The communicator (e.g., communication circuitry) 2030 may be configured to communicate with various types of external devices using various types of communication protocols. For example, the communicator 2030 may include at least one selected from a Wi-Fi chip 2031, a Bluetooth chip 2032, a wireless communication chip 2033, and a NFC chip 2034. The controller 2000 may be configured to communicate with various external devices via the communicator 2030.

The Wi-Fi chip 2031 and the Bluetooth chip 2032 may perform communication via the Wi-Fi protocol and the Bluetooth protocol, respectively. In the case of using the Wi-Fi chip 2031 or the Bluetooth chip 2032, communication may be established by transmitting various connection information, such as SSIDs and session keys, first, and then various information may be transmitted and received. The wireless communication chip 2033 may refer to a chip that performs communications via various communication protocols, such as IEEE, Zigbee, 3rd generation (3G), 3rd generation partnership project (3GPP), and long-term evolution (LTE). The NFC chip 2034 may refer to a chip that operates according to the near field communication (NFC) standard that uses a 13.56 MHz band from among various RF-ID frequency bands, such as 2040 kHz, 13.56 MHz, 433 MHz, 860-960 MHz, and 2.45 GHz.

The video processor 2040 may process video data included in content received via the communicator 2030 or content stored in the memory 2010. The video processor 2040 may perform various image processing operations, such as decoding, scaling, noise filtering, frame rate transformation, and resolution transformation, with respect to video data.

The audio processor 2070 may process audio data included in content received via the communicator 2030 or content stored in the memory 2010. The video processor 2040 may perform various processing operations, such as decoding, amplification, and noise filtering, with respect to audio data.

When a multimedia content player program is executed, the controller 2000 may be configured to control the video processor 2040 and the audio processor 2070 and play back corresponding content. The speaker unit 2090 may output audio data generated by the audio processor 2070.

The user input unit 2060 may receive various instructions from a user. For example, the user input unit 2060 may include at least one selected from a key 2061, the touch panel 2062, and a pen recognition panel 2063.

The key 2061 may, for example, include various types of keys, such as mechanical buttons and scroll wheels, formed at various regions of the body unit of the device 100 including a front region, a side region, and a rear region.

The touch panel 2062 may detect a touch input from a user and output a touch event value corresponding to a detected touch signal. If the touch panel 2062 is combined with the display panel 2051 to embody a touch screen (not shown), the touch screen may include various types of touch sensors, such as an electrostatic type, a resistive type, and a piezoelectric type. In the case of an electrostatic type touch screen, when a body part of a user touches a surface of the touch screen, coordinates of the touch are calculated by detecting fine electricity induced by the body part of the user. In the case of a resistive touch screen, when a user touches the touch screen, coordinates of the touch are calculated by detecting a current that flows as an upper plate and a lower plate at the touched location contact each other. Touch events occurring on a touch screen may be mainly generated by a person's fingers. However, touch events occurring on a touch screen may also be generated by an object formed of a conductive material that may induce changes in electrostatic capacitance.

The pen recognition panel 2063 may detect a proximity input or a touch input based on a user's operation of a touch pen (e.g., a stylus pen) or a digitizer pen and output a detected pen proximity event or a pen touch event. The pen recognition panel 2063 may be embodied based on electro-magnetic resonance (EMR), for example, and may detect a touch or a proximity input based on change of intensity of an electromagnetic field due to approach or contact of a pen. For example, the pen recognition panel 2063 may include an electromagnetic induction coil sensor (not shown) having a grid-like structure and an electromagnetic signal processing unit (not shown), which sequentially provides alternate current (AC) signals having a designated frequency to respective loop coils of the electromagnetic induction coil sensor. If a pen including a resonance circuit exists nearby a loop coil of the pen recognition panel 2063, a magnetic field emanating from the corresponding loop coil induces a current at the resonance circuit inside the pen based on mutual electromagnetic induction. Based on the current, an induced magnetic field is formed from coils constituting the resonance circuit inside the pen, and the pen recognition panel 2063 detects the induced magnetic field at the loop coil in a signal receiving mode, and thus a proximity location or a touch location regarding the pen may be detected. The pen recognition panel 2063 may be arranged at the bottom of the display panel 2051 with some area, e.g., an area sufficient to cover the display area of the display panel 2051.

The microphone 2080 may receive voice of a user or other sounds and transform the voice or the sounds into audio data. The controller 2000 may be configured to use voice of a user input via the microphone 2080 for a calling operation or transform the voice into audio data and store the audio data in the memory 2010.

The camera 2085 may pick up a still image or moving pictures under the control of a user. The camera 2085 may be embodied as a plurality of units, such as a front camera and a rear camera.

If the camera 2085 and the microphone 2080 are provided, the controller 2000 may be configured to control operations based on voice of a user input via the microphone 2080 or a motion of the user recognized by the camera 2085. For example, the device 100 may operate in a motion control mode or a voice control mode. If the device 100 operates in the motion control mode, the controller 2000 may activate the camera 2085, pick up images of a user, tracks changes of a motion of the user, and perform a corresponding control operation. If the device 100 operates in the voice control mode, the controller 2000 may operate in a voice recognition mode, in which a user's voice input via the microphone 2080 is analyzed and control operations are performed based on the analyzed voice of the user.

The motion detector 2095 may detect movement of the body unit of the device 100. The device 100 may be rotated or titled in various directions. The motion detector 2095 may detect motion characteristics, such as a rotating direction, a rotating angle, and a tilted angle, by using at least one selected from various sensors, such as a geomagnetic sensor, a gyro sensor, and an acceleration sensor.

Although not illustrated in FIG. 20, the device 100 may further include a USB port for connecting a USB connector, various external input ports for connecting various external terminals, such as a headset, a mouse, and a LAN, a digital multimedia broadcasting (DMB) chip for receiving and processing DMB signals, and various sensors.

Names of the components of the device 100 may vary. The device 100 may include at least one selected from the above-stated components, where some of the components may be omitted or additional components may be further arranged.

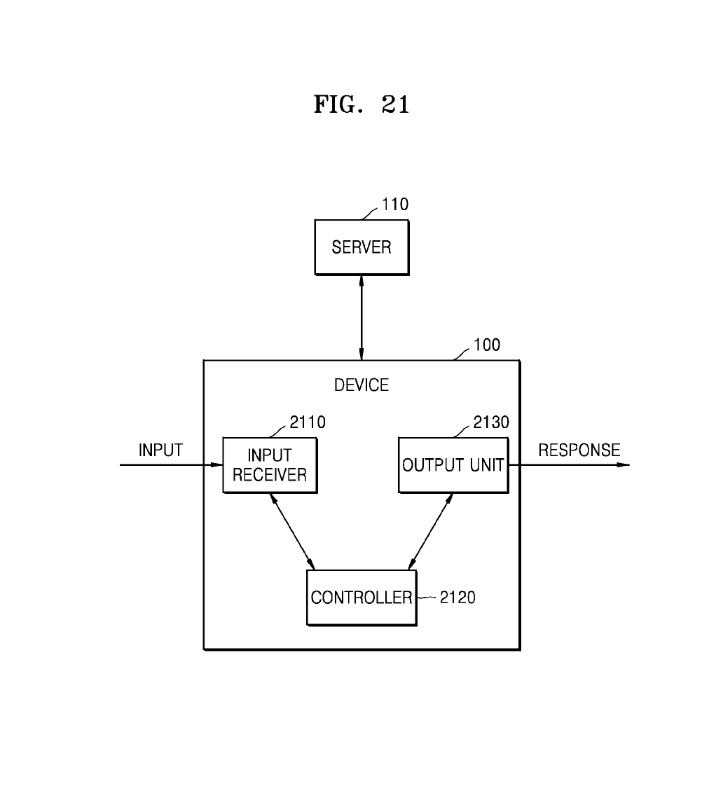

FIG. 21 is a block diagram illustrating an example configuration of the device 100.

Referring to FIG. 21, the device 100 may include an input receiver (e.g., input circuitry) 2110, a controller 2120, and an output unit (e.g., output circuitry) 2130.

The device 100 may include more or less components than those shown in FIG. 21.

More detailed descriptions thereof will be given below.

The touch panel 2062, the microphone, the camera 2085, and the motion detector 2095 of FIG. 20 may be included in the input receiver 2110 of the device 100. The controller 2000 of FIG. 20 may be included in the controller 2120 of the device 100. The display 2050 of FIG. 20 may be included in the output unit 2130 of the device 100.

The input receiver 2110 may receive inputs from outside of the input receiver 2110. For example, the input receiver 2110 may receive at least one selected from a touch input, a keyboard input, a voice input, a sound input, a button input, a gesture input, and a multimodal input.

The input receiver 2110 may include at least one selected from a camera, an infrared ray sensor, a motion sensor, a microphone, a touch panel, a gravity sensor, and an acceleration sensor.

The device 100 may receive user inputs from a plurality of users. For example, the device 100 may receive user inputs from a user group including a plurality of users. For example, the device 100 may receive voice inputs from a plurality of users via a sensor included in the device 100.

The input receiver 2110 may determine an input method. For example, the input receiver 2110 may determine an input method based on type of an input received from a user. The device 100 may determine a method of receiving a user input based on the determined input method.

For example, if the input receiver 2110 recognizes a sound from outside of the input receiver 2110, the input receiver 2110 may determine a sound input method as an input method. If the input receiver 2110 determines the sound input method as the input method, the input receiver 2110 may obtain an inquiry indicated by a sound input received via a microphone included in the input receiver 2110.

The input receiver 2110 may receive an input based on a determined input method. For example, if the input receiver 2110 determines a gesture input method as the input method, the input receiver 2110 may receive a gesture input from outside of the input receiver 2110 and obtain an inquiry indicated by the received gesture input.

The controller 2120 may be configured to obtain an inquiry indicated by an input received by the input receiver 2110. The controller 2120 may be configured to obtain an inquiry indicated by a received input.

For example, the controller 2120 may be configured to extract a keyword from a received input and obtains an inquiry indicated by the received input using the extracted keyword. For example, if the controller 2120 receives a text input “let us decide a restaurant and foods to order,” the controller 2120 may be configured to extract keywords “restaurant” and “order” and obtain an inquiry “what are foods offered by popular restaurants around a current location?”

In another example, if a received input corresponds to a pre-set input, the controller 2120 may be configured to obtain an inquiry indicated by the pre-set input. For example, if a gesture input pointing out a particular object is received, the controller 2120 may be configured to obtain an inquiry “what is the pointed-out object?”. In another example, if the controller 2120 receives a gesture input pointing out the sky, the controller 2120 may be configured to obtain an inquiry “how is today's weather?” In another example, if the controller 2120 receives a gesture input expressed by using a sign language, the controller 2120 may be configured to analyze an intention indicated by the sign language and obtain an inquiry indicated by the gesture input. In another example, if the controller 2120 receives a text input “time,” the controller 2120 may be configured to obtain an inquiry “what time is it now?”

In another example, the controller 2120 may be configured to obtain an inquiry indicated by a received input using the received input and user information. User information may include at least one selected from information regarding location of a user, current time information, information regarding a history of responses to a user, information regarding age of a user, and information regarding knowledge level of a user. Information regarding a history of responses to a user may refer to information regarding histories of inputs and responses related to a current user. For example, if a number of times that an inquiry “what are foods offered by popular restaurants around a current location?” is obtained in relation to a current user is equal to or greater than a certain number of times, the inquiry “what are foods offered by popular restaurants around a current location?” may be obtained even if only a keyword “restaurant” is obtained from an input from the current user. For example, if a keyword obtained from a user input is “how to go to home,” the controller 2120 may be configured to obtain an inquiry “what is a phone number of a call taxi company?” may be obtained in an early morning time and may obtain an inquiry “what is a number of a bus line to go to home from a current location?” in an evening time.

In another example, the controller 2120 may be configured to obtain an inquiry indicated by a received input using the received input and user information regarding a plurality of users constituting a user group. User information may include at least one selected from information regarding location of a user, current time information, information regarding a history of responses to a user, information regarding age of a user, and information regarding knowledge level of a user. Information regarding a history of responses to a user may refer to information regarding histories of inputs and responses related to a current user. When output unit 2130 outputs a response with respect to a user group, the controller 2120 may be configured to reflect preferences of users included in the user group. For example, if an inquiry is “where is a recommended place for a get-together?” the controller 2120 may be configured to analyze information regarding users included in a user group and output a restaurant preferred by most of the users as a response. In another example, if an inquiry is “where is a recommended place for a get-together?” the controller 2120 may be configured to output a restaurant with the most favorable evaluation from among restaurants determined as places for get-togethers in the past as a response.

If the controller 2120 fails to obtain an inquiry corresponding to a received input, the controller 2120 may be configured to receive an additional input from a user.

For example, if the controller 2120 fails to analyze a received input, the controller 2120 may be configured to display a screen image for requesting a user to apply an additional input. For example, if the controller 2120 fails to obtain a text from a received voice input, the controller 2120 may be configured to display a screen image for requesting a user to apply an additional input.

In another example, if there are a plurality of inquiries corresponding to a received input and priorities regarding the plurality of inquiries are equal, the controller 2120 may be configured to receive an additional input from a user to determine one inquiry corresponding to the received input.

If an additional input is received, the controller 2120 may be configured to obtain an inquiry based on the initially received input and the additional input.

For example, if a keyword obtained from the input initially received by the controller 2120 is “current” and a keyword obtained from the additional input is “time,” an inquiry “what time is it now?” may be obtained

The controller 2120 may be configured to determine a response level corresponding to a user level from among one or more pre-set response levels.

The controller 2120 may be configured to store one or more pre-set response levels.

For example, the controller 2120 may be configured to store a plurality of response levels determined based on ages. For example, the controller 2120 may be configured to store response levels corresponding to ages from 3 to 100. In another example, the controller 2120 may be configured to store response levels categorized into preschooler, schoolchild, teenager, young adult, prime of life, and old.

In another example, the controller 2120 may be configured to store a plurality of response levels determined based on knowledge levels. For example, the controller 2120 may store response levels categorized into elementary school graduate, junior high school graduate, high school graduate, university graduate, master's degree, and doctoral degree. In another example, the controller 2120 may be configured to store response levels categorized into beginner, intermediate, advanced, and expert. In another example, the controller 2120 may be configured to store response levels categorized into non-specialist, specialist, and expert. In another example, the controller 2120 may store response levels corresponding to levels from 1 to 100, respectively.

The controller 2120 may be configured to determine a response level corresponding to a user level. For example, the controller 2120 may be configured to determine a response level based on at least one selected from age information and knowledge level information regarding a user.

For example, the controller 2120 may be configured to determine one from among response levels categorized into preschooler, schoolchild, teenager, young adult, prime of life, and old as a response level corresponding to a user level. For example, if a user input is a child's voice, the controller 2120 may be configured to analyze the voice and determine a child response level as a response level corresponding to a user level. The controller 2120 may be configured to determine age of a user by analyzing characteristics of a received voice input and to determine a response level based on the determined age. For example, if characteristics of a received voice input correspond to characteristics of voice of a child, the controller 2120 may be configured to determine a child response level as a response level corresponding to the received voice input. The controller 2120 may be configured to obtain a text indicated by a voice from a received voice input and determine a response level by analyzing the obtained text. For example, if the obtained text includes childish words or childish expressions, the controller 2120 may be configured to determine a child response level as a response level corresponding to the received voice input.

In another example, the controller 2120 may be configured to determine one from among a plurality of pre-set response levels as a response level corresponding to a user level using age information or knowledge level information regarding a user, which is stored in the controller 2120 in advance or received from outside of the controller 2120. For example, the controller 2120 may be configured to receive information indicating that a knowledge level of a user applying an input corresponds to the expert level and determine a response level corresponding to the expert level as a response level appropriate for the user level.

The controller 2120 may be configured to determine a response level for each user based on data stored in the controller 2120. For example, if information regarding age or academic ability of a user is stored in the controller 2120, the controller 2120 may be configured to determine a response level corresponding to the age or the academic level of the user as a response level for the user.

The controller 2120 may be configured to determine a response level for each user based on inputs received from the user. For example, the controller 2120 may be configured to receive an input for determining level of a user from the user and determine a response level for the user. In another example, the controller 2120 may be configured to analyze an input received from a user and determine a response level for the user. For example, the controller 2120 may be configured to analyze voice tone of a user and determine age of the user or may analyze difficulty of vocabularies used by a user and determine knowledge level of the user.

The controller 2120 may provide a graphic user interface (GUI) for selecting a response level.

For example, the controller 2120 may be configured to receive an input for selecting a response level from a user via a GUI for selecting a number from 1 to 10.

In another example, the controller 2120 may be configured to receive an input for selecting a response level from a user by receiving an input for selecting one from among a plurality of images respectively indicating a plurality of response levels. For example, the controller 2120 may be configured to determine a child level as a response level if a character is selected and may determine an adult level as a response level if a landscape image is selected.

The controller 2120 may be configured to output a sample response that is anticipated to be output when a particular response level is selected from among a plurality of response levels. A user may refer to a sample response in case of applying an input for selecting one from among a plurality of response levels.

The output unit 2130 may output a response regarding an inquiry based on the response level determined by the controller 2120.

The controller 2120 may be configured to determine one or more responses corresponding to an inquiry. For example, the controller 2120 may be configured to obtain a plurality of responses corresponding to an inquiry “what movies are popular these days?” For example, the plurality of responses may correspond to a first movie popular between preschoolers, a second move popular between teenagers, and a third move popular between adults.

The controller 2120 may be configured to determine one response of one or more responses corresponding to the obtained inquiry. For example, the controller 2120 may be configured to determine one response from among responses including a first movie, a second movie, and a third movie corresponding to the inquiry “what movies are popular these days?” based on a user level.

The controller 2120 may be configured to obtain user information. User information may, for example, include at least one selected from information regarding location of a user, current time information, information regarding a history of responses to a user, information regarding age of a user, and information regarding knowledge level of a user. For example, the controller 2120 may be configured to store user information in advance. In another example, the controller 2120 may be configured to receive and store user information.

Information regarding a history of responses may include information regarding feedback provided by a user about responses provided to the user in the past. For example, if the output unit 2130 receives a text “restaurant” from a user and outputs a restaurant A as an inquiry, the user may input a restaurant B in the form of a text as feedback information. For example, the output unit 2130 may output a response later by reflecting the feedback information “restaurant B” thereto. For example, the output unit 2130 may output the restaurant B as a response when a same text “restaurant” is input later.

Feedback information may be input to the output unit 2130 in various ways. For example, feedback information may be input to the output unit 2130 via at least one selected from a text input, a gesture input, a voice input, a sketch input, and a multimodal input. More detailed descriptions thereof were discussed above with reference to FIGS. 6 to 11.

The output unit 2130 may output one response of one or more responses corresponding to an inquiry based on at least one selected from the response level determined by the controller 2120 and user information.

For example, the controller 2120 may be configured to determine one response from among responses including a first movie, a second movie, and a third movie corresponding to the inquiry “what movies are popular these days?” based on information regarding age of a user included in the user information.

The output unit 2130 may output a determined response. For example, the output unit 2130 may output a determined response as at least one selected from a text, a voice, an image, and a moving picture. For example, if a determined response is “17 o'clock,” the output unit 2130 may display a text “17 o'clock,” may play back a voice saying “17 o'clock,” may display a clock image indicating “17 o'clock,” or display a clock animation indicating a current time.

The output unit 2130 may output different responses with respect to a same inquiry and a same response level, based on circumstances. For example, the output unit 2130 may first output a response “Seoul” with respect to a first inquiry “what is current location?” and may output a response “Dogok-dong, Seoul” with respect to a second inquiry “what is current location?”. In another example, the output unit 2130 may first output a response regarding today's weather with respect to a first inquiry “how is the weather?” and may output a response regarding this week's weather with respect to a second inquiry “how is the weather?”. For example, the output unit 2130 may output different responses with respect to a same inquiry, based on a current time and/or a current location. For example, for a same inquiry “how to go to home” obtained from a same user, the output unit 2130 may output a response “phone number of a call taxi company” in an early morning time and may output “a number of a bus line to go to home from a current location?” in an evening time.

The output unit 2130 may output a same response with respect to a same inquiry and a same response level. For example, the output unit 2130 may always output a current location to the street number level in correspondence to an inquiry “what is current location?”

One or more example embodiments may be implemented by a non-transitory computer-readable recording medium, such as a program module executed by a computer. The non-transitory computer-readable recording medium may be an arbitrary available medium accessible by a computer, and examples thereof include all volatile media (e.g., RAM) and non-volatile media (e.g., ROM) and separable and non-separable media. Further, examples of the non-transitory computer-readable recording medium may include a computer storage medium and a communication medium. Examples of the computer storage medium include all volatile and non-volatile media and separable and non-separable media, which have been implemented by an arbitrary method or technology, for storing information such as computer-readable commands, data structures, program modules, and other data. The communication medium typically include a computer-readable command, a data structure, a program module, other data of a modulated data signal, or another transmission mechanism, and an example thereof includes an arbitrary information transmission medium.

While the disclosure has been described with reference to example embodiments thereof, it will be understood by those of ordinary skill in the art that various changes in form and details may be made therein without departing from the spirit and scope of the disclosure as defined by the following claims. It will be understood that the example embodiments described above are not limiting the scope of the disclosure. For example, each component described in a single type may be executed in a distributed manner, and components described distributed may also be executed in an integrated form.

The scope of the disclosure is indicated by the claims which will be described in the following rather than the detailed description, and it should be understood that the claims and all modifications or modified forms drawn from the concept of the claims are included in the scope of the disclosure.

What is claimed is:

1. A method for outputting a response to an inquiry comprising:
receiving an input;
obtaining an inquiry indicated by the input;
determining a response level corresponding to a user level of a user from among one or more pre-set response levels; and
outputting a response to the inquiry based on the determined response level.

2. The method of claim 1, wherein the obtaining of the inquiry comprises:
determining a method by which the input is performed; and
receiving the input based on the determined input method.

3. The method of claim 2, wherein the input method comprises at least one of a touch input method, a keyboard input method, a sound input method, a gesture input method, and an image input method.

4. The method of claim 1, wherein the outputting of the response comprises:
obtaining information regarding the user;
determining one or more responses corresponding to the inquiry; and
outputting one response from among the one or more responses based on at least one of the determined response level and the information regarding the user.

5. The method of claim 4, wherein the information regarding the user comprises at least one of information regarding a location of the user, current time information, information regarding a history of responses to the user, information regarding an age of the user, and information regarding a knowledge level of the user.

6. The method of claim 1, wherein the obtaining of the inquiry comprises:
obtaining a keyword based on the input; and
obtaining an inquiry using the keyword.

7. The method of claim 1, wherein the obtaining of the inquiry comprises: obtaining an inquiry indicated by the input obtained using at least one of information regarding a location of the user, current time information, information regarding a history of responses to the user, information regarding an age of the user, and information regarding a knowledge level of the user.

8. The method of claim 1, wherein the obtaining of the inquiry comprises:
receiving an additional input if the inquiry corresponding to the input is not obtained; and
obtaining the inquiry using the additional input.

9. The method of claim 1, wherein the determining of the response level comprises: determining the response level using at least one of information regarding an age of the user and information regarding a knowledge level of the user.

10. The method of claim 1, wherein the outputting of the response comprises:
outputting the response as at least one of a text, a voice, and an image.

11. A device comprising:
input circuitry configured to receive an input and to obtain an inquiry indicated by the input;
a controller configured to determine a response level corresponding to a user level of a user from among one or more pre-set response levels; and
output circuitry configured to output a response to the inquiry based on the determined response level.

12. The device of claim 11, wherein the input circuitry is configured to determine an input method for the input and to receive the input based on the determined input method.

13. The device of claim 12, wherein the input method comprises: at least one of a touch input method, a keyboard input method, a sound input method, a gesture input method, and an image input method.

14. The device of claim 11, wherein the controller is configured to obtain information regarding the user, to determine one or more responses corresponding to the inquiry, and to output one response from among the one or more responses based on at least one of the determined response level and the information regarding the user.

15. The device of claim 14, wherein the information regarding the user comprises: at least one of information regarding a location of the user, current time information, information regarding a history of responses to the user, information regarding an age of the user, and information regarding a knowledge level of the user.

16. The device of claim 11, wherein the controller is configured to obtain a keyword using the input and to obtain an inquiry indicated by the input using the keyword.

17. The device of claim 11, wherein the controller is configured to obtain an inquiry indicated by the input using at least one of information regarding a location of the user, current time information, information regarding a history of responses to the user, information regarding an age of the user, and information regarding a knowledge level of the user.

18. The device of claim 11, wherein, the input circuitry is configured to receive an additional input if the inquiry corresponding to the input is not obtained, and
the controller is configured to obtain the inquiry using the additional input.

19. The device of claim 11, wherein the controller is configured to determine the response level using at least one of information regarding an age of the user and information regarding a knowledge level of the user.

20. The device of claim 11, wherein the controller is configured to output the response as at least one of a text, a voice, and an image.

21. A non-transitory computer readable recording medium having recorded thereon a computer program for implementing the method of claim 1.
